(19) United States
(12) Patent Application Publication
(10) Pub. No.: US 2023/0103503 A1
(43) Pub. Date: Apr. 6, 2023

(54) ADAPTING CONNECTED MODE DISCONTINUOUS RECEPTION PARAMETERS BASED ON TRAFFIC CHARACTERISTICS

(71) Applicant: QUALCOMM Incorporated, San Diego, CA (US)

(72) Inventors: Olufunmilola Omolade AWONIYI-OTERI, San Diego, CA (US); Tao LUO, San Diego, CA (US); Juan MONTOJO, San Diego, CA (US); Junyi LI, Fairless Hills, PA (US); Peter GAAL, San Diego, CA (US); Prashanth Haridas HANDE, San Diego, CA (US); Peerapol TINNAKORNSRISUPHAP, San Diego, CA (US); Wooseok NAM, San Diego, CA (US); Aleksandar DAMNJANOVIC, Del Mar, CA (US); Jelena DAMNJANOVIC, Del Mar, CA (US)

(21) Appl. No.: 17/821,103

(22) Filed: Aug. 19, 2022

Related U.S. Application Data
(60) Provisional application No. 63/261,927, filed on Sep. 30, 2021.

(51) Int. Cl. H04W 76/28

(52) U.S. Cl. CPC H04W 76/28

(57) ABSTRACT

Various aspects of the present disclosure generally relate to wireless communication. In some aspects, a user equipment (UE) may receive a wake-up signal or a downlink communication (e.g., a physical downlink control channel (PDCCH) communication or a physical downlink shared channel (PDSCH) communication) that include one or more connected mode discontinuous reception (CDRX) parameters. The UE may perform an operation associated with a CDRX cycle based at least in part on the one or more CDRX parameters. Numerous other aspects are described.

### CROSS-REFERENCE TO RELATED APPLICATION

This Patent Application claims priority to U.S. Provisional Pat. Application No. 63/261,927, filed on Sep. 30, 2021, entitled “ADAPTING CONNECTED MODE DISCONTINUOUS RECEPTION PARAMETERS BASED ON TRAFFIC CHARACTERISTICS,” and assigned to the assignee hereof. This prior Application is considered part of and is incorporated by reference into this Patent Application in its entirety.

### FIELD OF THE DISCLOSURE

Aspects of the present disclosure generally relate to wireless communication and to techniques and apparatuses for adapting connected mode discontinuous reception (CDRX) parameters based on traffic characteristics.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving a wake-up signal including one or more connected mode discontinuous reception (CDRX) parameters. The method may include performing an operation associated with a CDRX cycle based at least in part on the one or more CDRX parameters.

Some aspects described herein relate to a method of wireless communication performed by a base station. The method may include determining one or more CDRX parameters to be applied by a UE to a CDRX cycle. The method may include transmitting a wake-up signal including the one or more CDRX parameters.

Some aspects described herein relate to a method of wireless communication performed by a UE. The method may include receiving one or more downlink communications including one or more CDRX parameters, where the one or more downlink communications include at least one of a physical downlink control channel (PDCCH) communication or a physical downlink shared channel (PDSCH) communication. The method may include performing an operation associated with a CDRX cycle based at least in part on the one or more CDRX parameters.

Some aspects described herein relate to a method of wireless communication performed by a base station. The method may include determining one or more CDRX parameters to be applied by a UE to a CDRX cycle. The method may include transmitting one or more downlink communications including the one or more CDRX parameters, where the one or more downlink communications include at least one of a PDCCH communication or a PDSCH communication.

Some aspects described herein relate to a UE for wireless communication. The user equipment may include a memory and one or more processors coupled to the memory. The one or more processors may be configured to receive a wake-up signal including one or more CDRX parameters. The one or more processors may be configured to perform an operation associated with a CDRX cycle based at least in part on the one or more CDRX parameters.

Some aspects described herein relate to a base station for wireless communication. The base station may include a memory and one or more processors coupled to the memory. The one or more processors may be configured to determine one or more CDRX parameters to be applied by a UE to a CDRX cycle. The one or more processors may be configured to transmit a wake-up signal including the one or more CDRX parameters.

Some aspects described herein relate to a UE for wireless communication. The user equipment may include a memory and one or more processors coupled to the memory. The one or more processors may be configured to receive one or more downlink communications including one or more CDRX parameters. The one or more processors may be configured to perform an operation associated with a CDRX cycle based at least in part on the one or more CDRX parameters.

Some aspects described herein relate to a base station for wireless communication. The base station may include a memory and one or more processors coupled to the memory. The one or more processors may be configured to determine one or more CDRX parameters to be applied by a UE to a CDRX cycle. The one or more processors may be configured to transmit one or more downlink communications including the one or more CDRX parameters.

Some aspects described herein relate to a non-transitory computer-readable medium that stores a set of instructions for wireless communication by a UE. The set of instructions, when executed by one or more processors of the UE, may cause the UE to receive a wake-up signal including one or more CDRX parameters. The set of instructions, when executed by one or more processors of the UE, may cause the UE to perform an operation associated with a CDRX cycle based at least in part on the one or more CDRX parameters.

Some aspects described herein relate to a non-transitory computer-readable medium that stores a set of instructions for wireless communication by a base station. The set of instructions, when executed by one or more processors of the base station, may cause the base station to determine one or more CDRX parameters to be applied by a UE to a CDRX cycle. The set of instructions, when executed by one or more processors of the base station, may cause the base station to transmit a wake-up signal including the one or more CDRX parameters.

Some aspects described herein relate to a non-transitory computer-readable medium that stores a set of instructions for wireless communication by a UE. The set of instructions, when executed by one or more processors of the UE, may cause the UE to receive one or more downlink communications including one or more CDRX parameters. The set of instructions, when executed by one or more processors of the UE, may cause the UE to perform an operation associated with a CDRX cycle based at least in part on the one or more CDRX parameters.

Some aspects described herein relate to a non-transitory computer-readable medium that stores a set of instructions for wireless communication by a base station. The set of instructions, when executed by one or more processors of the base station, may cause the base station to determine one or more CDRX parameters to be applied by a UE to a CDRX cycle. The set of instructions, when executed by one or more processors of the base station, may cause the base station to transmit one or more downlink communications including the one or more CDRX parameters.

Some aspects described herein relate to an apparatus for wireless communication. The apparatus may include means for receiving a wake-up signal including one or more CDRX parameters. The apparatus may include means for performing an operation associated with a CDRX cycle based at least in part on the one or more CDRX parameters.

Some aspects described herein relate to an apparatus for wireless communication. The apparatus may include means for determining one or more CDRX parameters to be applied by a UE to a CDRX cycle. The apparatus may include means for transmitting a wake-up signal including the one or more CDRX parameters.

Some aspects described herein relate to an apparatus for wireless communication. The apparatus may include means for receiving one or more downlink communications including one or more CDRX parameters, where the one or more downlink communications include at least one of a PDCCH communication or a PDSCH communication. The apparatus may include means for performing an operation associated with a CDRX cycle based at least in part on the one or more CDRX parameters.

Some aspects described herein relate to an apparatus for wireless communication. The apparatus may include means for determining one or more CDRX parameters to be applied by a UE to a CDRX cycle. The apparatus may include means for transmitting one or more downlink communications including the one or more CDRX parameters, where the one or more downlink communications include at least one of a PDCCH communication or a PDSCH communication.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of a configuration for discontinuous reception (DRX), in accordance with the present disclosure

FIGS. 4A-4D are diagrams associated with a first example associated with adapting connected mode discontinuous reception (CDRX) parameters based on traffic characteristics, in accordance with the present disclosure.

FIGS. 5A-5C are diagrams associated with a second example associated with adapting CDRX parameters based on traffic characteristics, in accordance with the present disclosure.

FIGS. 6-9 are diagrams illustrating example processes associated with adapting CDRX parameters based on traffic characteristics, in accordance with the present disclosure.

FIGS. 10 and 11 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

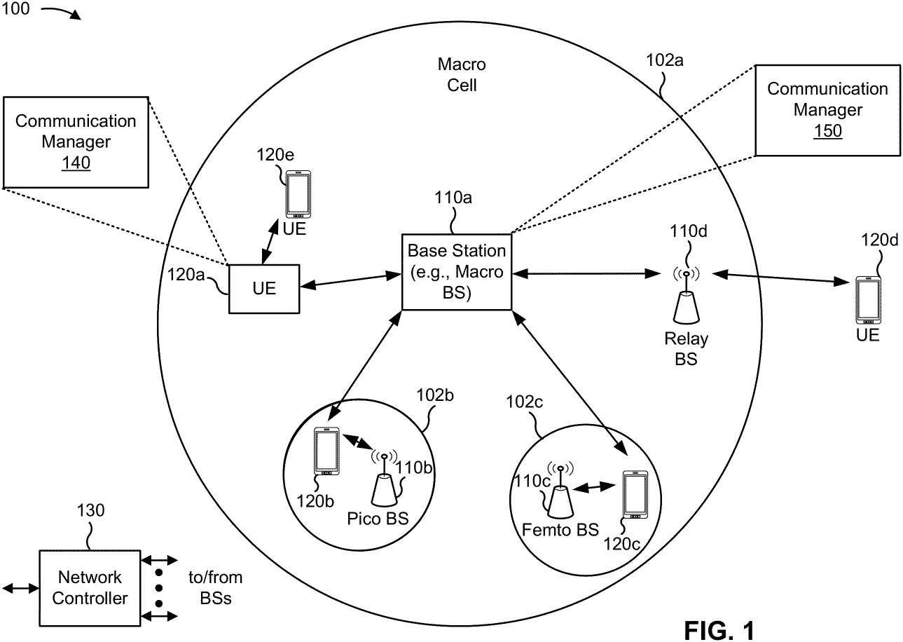

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz - 7.125 GHz) and FR2 (24.25 GHz - 52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz - 300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz - 24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5 G NR operation beyond 52.6 GHz. For example, three higher operating bands have been identified as frequency range designations FR4a or FR4-1 (52.6 GHz - 71 GHz), FR4 (52.6 GHz - 114.25 GHz), and FR5 (114.25 GHz - 300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a wake-up signal including one or more CDRX parameters; and perform an operation associated with a CDRX cycle based at least in part on the one or more CDRX parameters. Additionally, or alternatively, the communication manager 140 may perform one or more other operations described herein.

As described in more detail elsewhere herein, the communication manager 140 may receive one or more downlink communications including one or more CDRX parameters, wherein the one or more downlink communications include at least one of a PDCCH communication or a PDSCH communication; and perform an operation associated with a CDRX cycle based at least in part on the one or more CDRX parameters. Additionally, or alternatively, the communication manager 140 may perform one or more other operations described herein.

In some aspects, the base station 110 may include a communication manager 150. As described in more detail elsewhere herein, the communication manager 150 may determine one or more CDRX parameters to be applied by a UE 120 to a CDRX cycle; and transmit a wake-up signal including the one or more CDRX parameters. Additionally, or alternatively, the communication manager 150 may perform one or more other operations described herein.

As described in more detail elsewhere herein, the communication manager 150 may determine one or more CDRX parameters to be applied by a UE 120 to a CDRX cycle; and transmit one or more downlink communications including the one or more CDRX parameters, wherein the one or more downlink communications include at least one of a PDCCH communication or a PDSCH communication. Additionally, or alternatively, the communication manager 150 may perform one or more other operations described herein.

As indicated above, FIG. 1 is provided as an example. Other examples may differ from what is described with regard to FIG. 1.

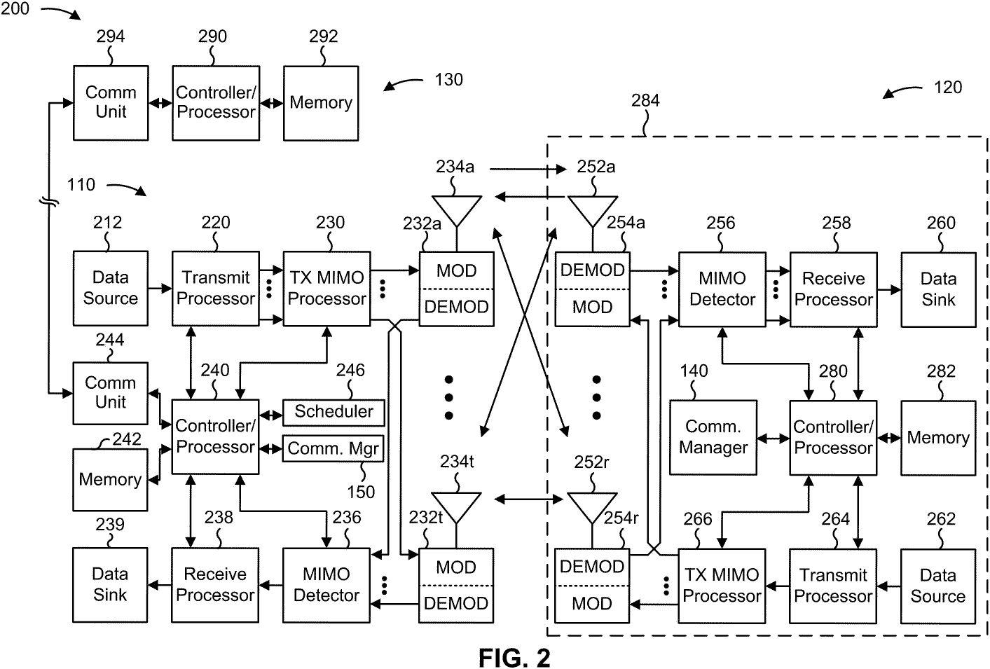

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T ≥ 1). The UE 120 may be equipped with a set of antennas 252a through 252r, such as R antennas (R ≥ 1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

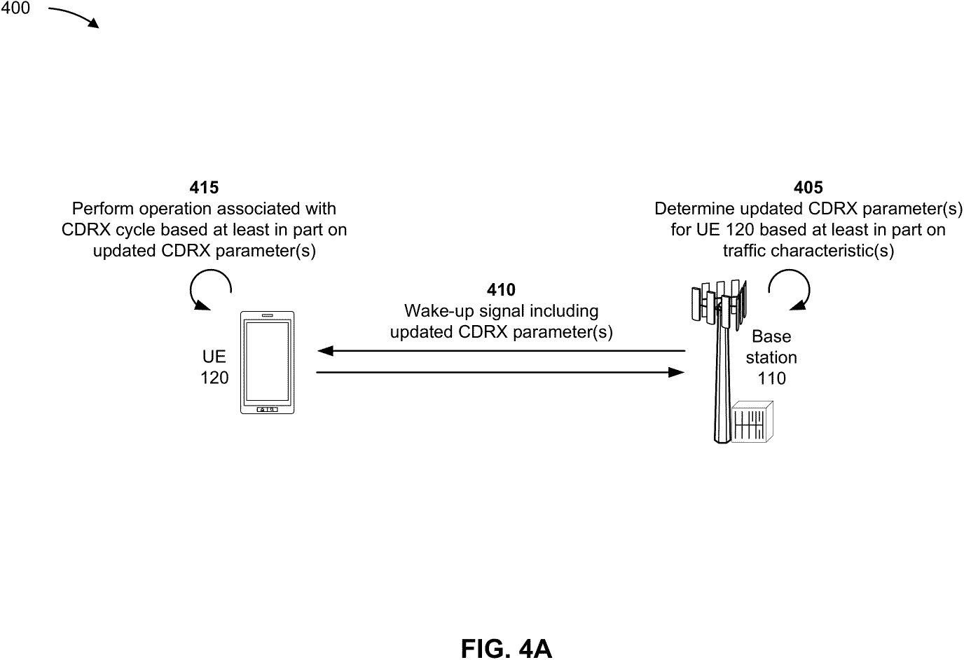

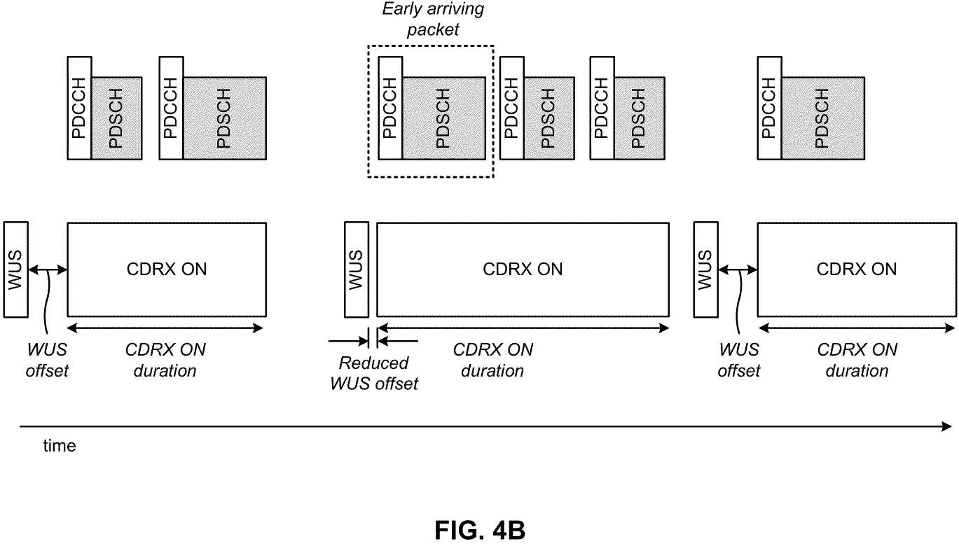

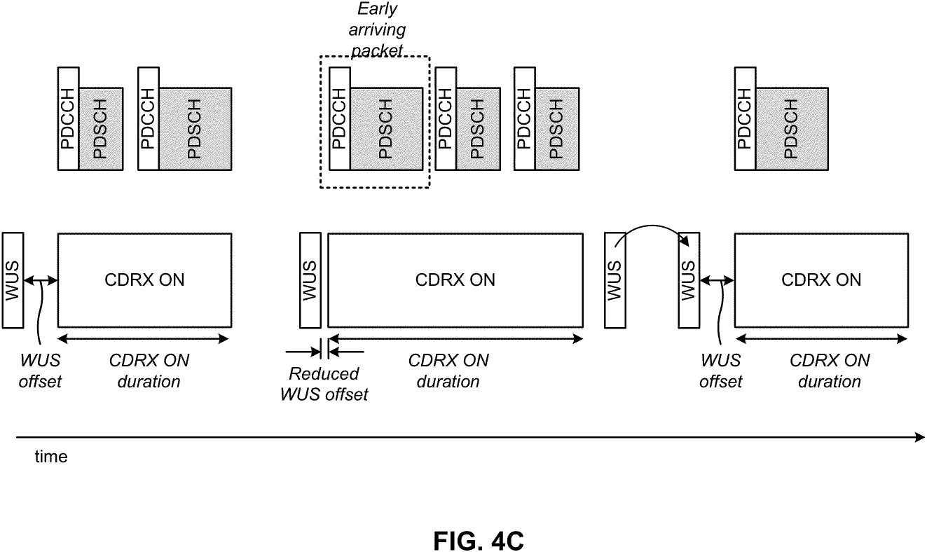

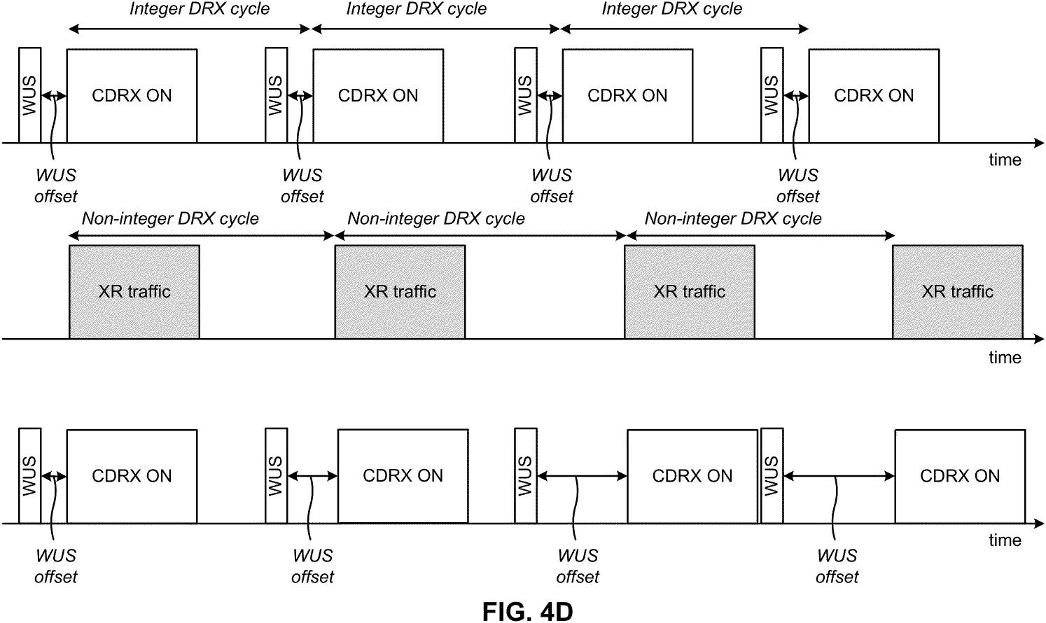

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIG. 4A-11).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIG. 4A-11).

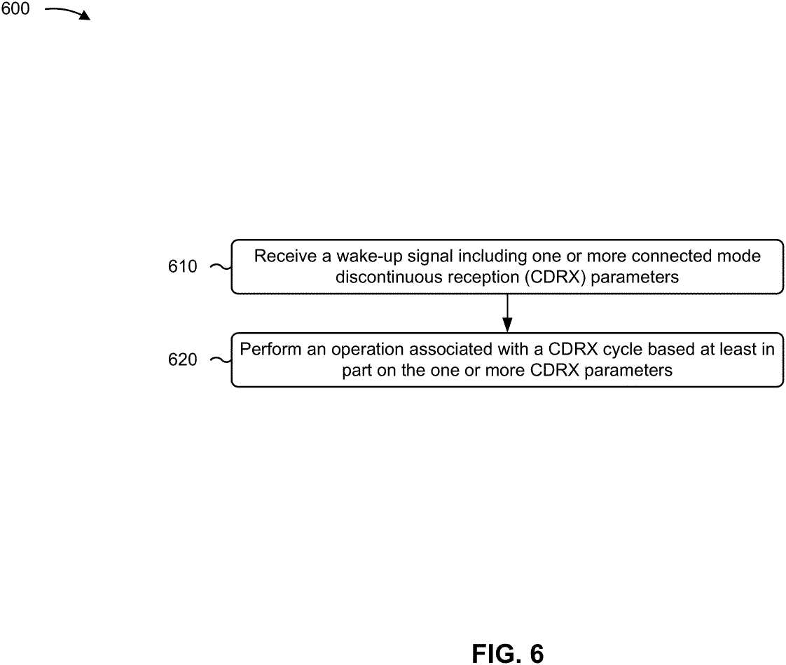

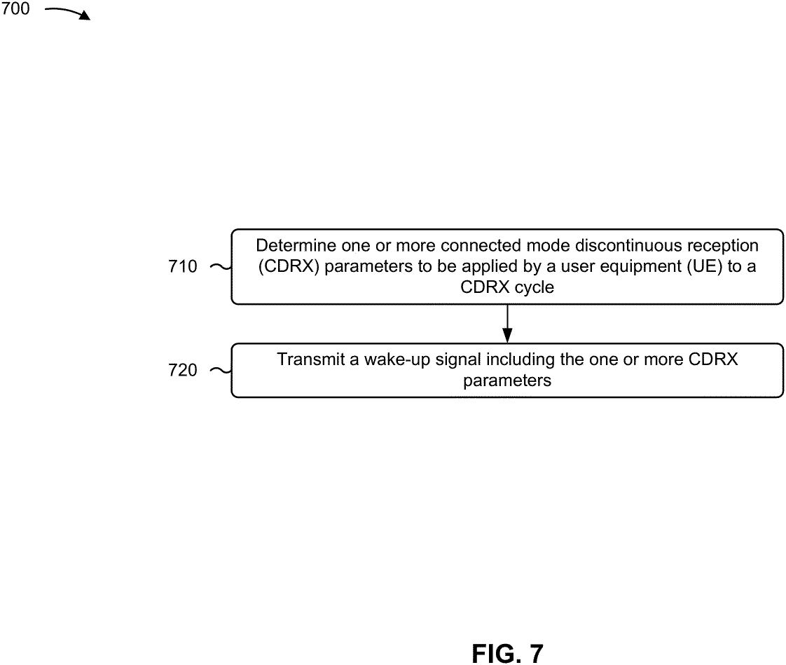

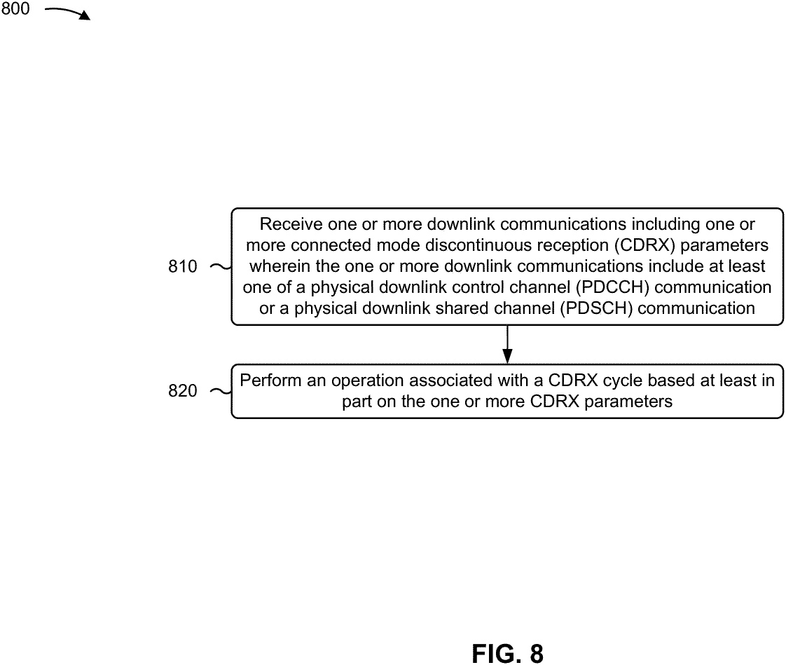

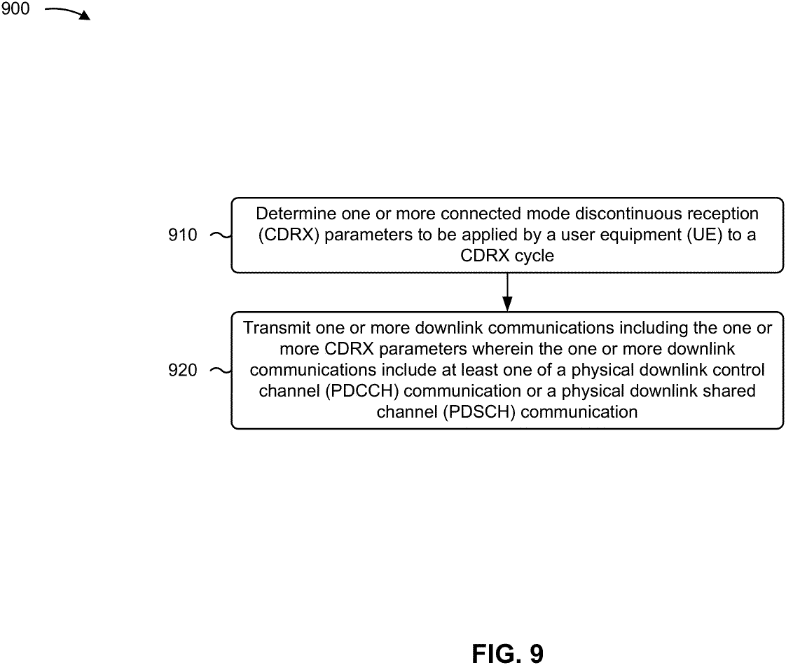

The controller/processor 240 of the base station 110, the controller/processor 280 of the UE 120, and/or any other component(s) of FIG. 2 may perform one or more techniques associated with adapting CDRX parameters based on traffic characteristics, as described in more detail elsewhere herein. For example, the controller/processor 240 of the base station 110, the controller/processor 280 of the UE 120, and/or any other component(s) of FIG. 2 may perform or direct operations of, for example, process 600 of FIG. 6, process 700 of FIG. 7, process 800 of FIG. 8, process 900 of FIG. 9, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 600 of FIG. 6, process 700 of FIG. 7, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, the UE 120 includes means for receiving a wake-up signal including one or more CDRX parameters; and/or means for performing an operation associated with a CDRX cycle based at least in part on the one or more CDRX parameters. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the base station 110 includes means for determining one or more CDRX parameters to be applied by a UE 120 to a CDRX cycle; and/or means for transmitting a wake-up signal including the one or more CDRX parameters. The means for the base station 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, the UE 120 includes means for receiving one or more downlink communications including one or more CDRX parameters, wherein the one or more downlink communications include at least one of a PDCCH communication or a PDSCH communication; and/or means for performing an operation associated with a CDRX cycle based at least in part on the one or more CDRX parameters. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the base station 110 includes means for determining one or more CDRX parameters to be applied by a UE 120 to a CDRX cycle; and/or means for transmitting one or more downlink communications including the one or more CDRX parameters, wherein the one or more downlink communications include at least one of a PDCCH communication or a PDSCH communication. The means for the base station 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

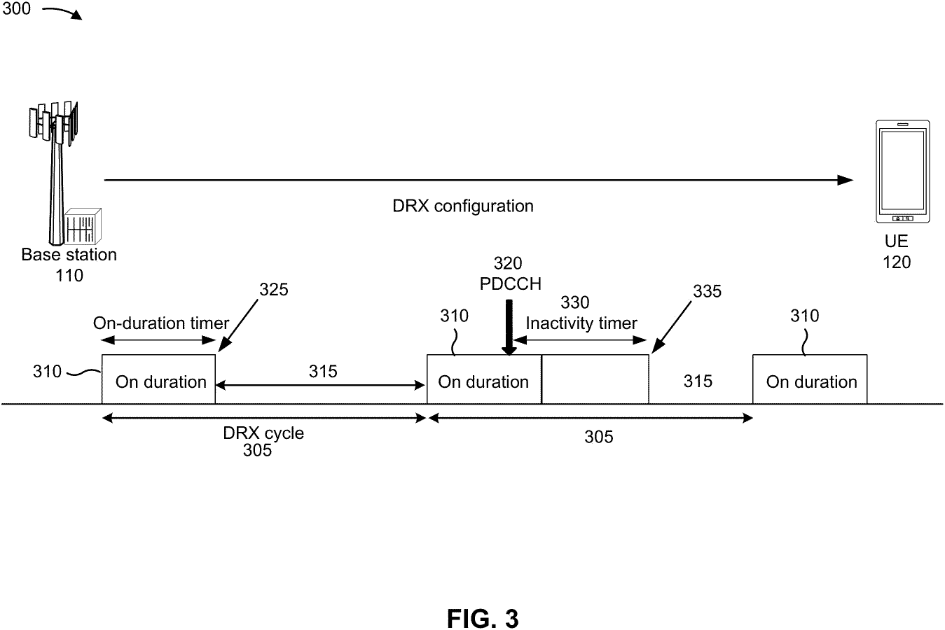

FIG. 3 is a diagram illustrating an example 300 of a discontinuous reception (DRX) configuration, in accordance with the present disclosure. In general, DRX can be used by a UE 120 operating in a radio resource control (RRC) idle mode when monitoring for paging messages. DRX avoids the UE 120 having to monitor all physical downlink control channel (PDCCH) transmission opportunities and, therefore, helps conserve battery power. DRX can also be used by a UE 120 operating in an RRC connected mode to help conserve battery power. Connected mode DRX (CDRX) takes advantage of periods of inactivity by allowing the UE 120 to enter a sleep state during which the UE 120 is not required to monitor the PDCCH. Typically, the UE 120 periodically wakes up to monitor the PDCCH in case there is a requirement to receive a downlink resource allocation. The UE 120 is permitted to interrupt the sleep state to send a scheduling request (SR) and in association with initiating an uplink transmission.

As shown in FIG. 3, a base station 110 may transmit a DRX configuration to a UE 120 to configure a DRX cycle 305 for the UE 120. A DRX cycle 305 may include a DRX ON duration 310 (e.g., a period of time during which a UE 120 is DRX active, meaning that the UE 120 is awake or in an active state) and an opportunity to enter a DRX sleep state 315. As used herein, the period of time during which the UE 120 is configured to be in an active state during the DRX ON duration 310 may be referred to as an active time, and the period of time during which the UE 120 is configured to be in the DRX sleep state 315 may be referred to as an inactive time. As described below, the UE 120 may monitor a PDCCH during the active time, and may refrain from monitoring the PDCCH during the inactive time.

During the DRX ON duration 310 (e.g., the active time), the UE 120 may monitor a downlink control channel (e.g., a PDCCH), as shown by reference number 320. For example, the UE 120 may monitor the PDCCH for downlink control information (DCI) pertaining to the UE 120. If the UE 120 does not detect and/or successfully decode any PDCCH communications intended for the UE 120 during the DRX ON duration 310, then the UE 120 may enter the sleep state 315 (e.g., for the inactive time) at the end of the DRX ON duration 310, as shown by reference number 325. In this way, the UE 120 may conserve battery power and reduce power consumption. As shown, the DRX cycle 305 may repeat with a configured periodicity according to the DRX configuration.

If the UE 120 detects and/or successfully decodes a PDCCH communication intended for the UE 120, then the UE 120 may remain in an active state (e.g., awake) for the duration of an inactivity timer 330 (e.g., which may extend the active time). The UE 120 may start the inactivity timer 330 at a time at which the PDCCH communication is received (e.g., in a transmission time interval (TTI) in which the PDCCH communication is received, such as a slot or a subframe). The UE 120 may remain in the active state until the inactivity timer 330 expires, at which time the UE 120 may enter the sleep state 315 (e.g., for the inactive time), as shown by reference number 335. During the duration of the inactivity timer 330, the UE 120 may continue to monitor for PDCCH communications, may obtain a downlink data communication (e.g., on a downlink data channel, such as a physical downlink shared channel (PDSCH)) scheduled by the PDCCH communication, and/or may prepare and/or transmit an uplink communication (e.g., on a physical uplink shared channel (PUSCH)) scheduled by the PDCCH communication. The UE 120 may restart the inactivity timer 330 after each detection of a PDCCH communication for the UE 120 for an initial transmission (e.g., but not for a retransmission). By operating in this manner, the UE 120 may conserve battery power and reduce power consumption by entering the sleep state 315.

Notably, a longer DRX cycle 305 would increase battery power savings, but would also increase latency. The base station 110 is unable to forward downlink data to the UE 120 while the UE 120 is in the sleep state 315. Rather, the base station 110 waits for the UE 120 be in the active state before allocating resources and forwarding downlink data. The average wait time increases for DRX cycles 305 with longer durations. In general, the transfer of uplink data is not delayed by the DRX cycle 305 because the UE 120 is permitted to interrupt the sleep state 315 to send an SR. However, the base station 110 may align timing of the SR period with the timing of the DRX cycle 305, meaning that the UE 120 could in some cases be restricted to sending SRs only when the UE 120 is in the active state (or just prior to being in the active state). In this case, the UE 120 and the base station 110 have similar average waiting periods when there is a requirement to transfer data. The base station 110 may provide the UE 120 with a configuration (e.g., DRX-Config) that provides the UE 120 with parameters used for the operation of CDRX. The CDRX parameters may include the inactivity timer 330 and a DRX ON duration 310, among other examples.

In some aspects, as described herein, the base station 110 may determine one or more CDRX parameters to be applied by a UE 120 based at least in part on a characteristic of traffic communicated between the base station 110 and the UE 120. Here, the base station 110 may transmit, and the UE 120 may receive, an indication of the one or more CDRX parameters. The UE 120 may then perform an operation associated with one or more DRX cycles 305 based at least in part on the one or more CDRX parameters.

As indicated above, FIG. 3 is provided as an example. Other examples may differ from what is described with respect to FIG. 3.

Some types of traffic in a wireless network may have characteristics that change or vary over time. For example, extended reality (XR) traffic may be communicated in (e.g., periodic) bursts, where each burst may include one packet or multiple packets. Notably, a quantity of packets may vary among bursts, and a packet size may vary among packets in a given burst. Further, times between arrivals of packets in a given burst can vary based on jitter, which may be a function of, for example, an encoding delay or a transmission route. Additionally, in the case of XR traffic, there may be multiple streams of data with different packet delay budgets (PDBs) or different inter-arrival periods, among other examples.

For an application with traffic having characteristics that change or vary over time, such as an XR application, UE power consumption is an important consideration. However, because characteristics of the traffic change or vary over time, a typical power saving technique, such as a typical CDRX mode of operation, may be ill-suited to enable UE 120 power savings in an XR application. Further, the typical CDRX mode of operation may result in increased latency or other performance related issues in an XR application.

As one particular example, a CDRX ON duration used by a UE 120 is typically fixed according to a DRX configuration provided by a base station 110. However, if a packet to be forwarded by the base station 110 to the UE 120 arrives at the base station 110 earlier than anticipated by the base station 110 (e.g., prior to a period of time when the UE 120 is in the active state) or later than anticipated by the base station 110 (e.g., after a period of time when the UE 120 is in the active state), then the base station 110 may need to transmit the packet to the UE 120 during a next CDRX ON duration. However, in such cases, the delay in transmission of the packet may lead to a PDB of the packet being violated. Thus, even though some power savings are achieved, the UE 120 experiences capacity loss due to the delay exceeding the PDB. Notably, a delay associated with a late-arriving packet may be greater than a delay associated with an early-arriving packet. In these scenarios, a longer CDRX ON duration may resolve the issue of early or late arriving packets. However, the longer CDRX ON duration would lead to wasted power consumption due to variations or changes in characteristics of the traffic over time.

Some techniques and apparatuses described herein enable adaptation of CDRX parameters based on traffic characteristics. In some aspects, a base station 110 may determine one or more CDRX parameters to be applied by a UE 120. In some aspects, the base station 110 may determine the one or more CDRX parameters based at least in part on a characteristic of traffic communicated between the base station 110 and the UE 120. Here, the base station 110 may transmit, and the UE 120 may receive, information associated with the one or more CDRX parameters. In some aspects, the information associated with the one or more CDRX parameters may be communicated in a wake-up signal, a PDCCH communication, a PDSCH communication, or some combination thereof. The UE 120 may then perform an operation associated with one or more CDRX cycles based at least in part on the one or more CDRX parameters. Additional details are provided below.

FIGS. 4A-4D are diagrams associated with an example 400 associated with adapting CDRX parameters based on traffic characteristics, in accordance with the present disclosure. As shown in FIG. 4A, example 400 includes communication between a base station 110 and a UE 120. In some aspects, the base station 110 and the UE 120 may be included in a wireless network, such as a wireless network 100. The base station 110 and the UE 120 may communicate via a wireless access link, which may include an uplink and a downlink.

As shown in FIG. 4A, by reference 405, the base station 110 may determine one or more CDRX parameters to be applied by the UE 120 to a CDRX cycle (e.g., an upcoming CDRX cycle). In some aspects, the one or more CDRX parameters may be updated CDRX parameters. For example, the base station 110 may configure the UE 120 with a DRX configuration at an earlier time, with the DRX configuration specifying an initial set of CDRX parameters. Here, the one or more CDRX parameters may include updated configurations for one or more of the CDRX parameters configured in the initial set of CDRX parameters.

In some aspects, the one or more CDRX parameters include a wake-up signal offset (e.g., an offset between a wake-up signal and a start of a CDRX ON duration). In some aspects, the one or more CDRX parameters include timing information for a wake-up associated with an upcoming CDRX ON duration (e.g., information indicating a time at which the UE 120 is to wake up for the upcoming CDRX ON duration). In some aspects, the one or more updated CDRX parameters include a CDRX ON duration. In some aspects, the one or more CDRX parameters include an inactivity timer. In some aspects, the one or more CDRX parameters include a PDCCH monitoring periodicity (e.g., a periodicity at which the UE 120 is to monitor the PDCCH during a given CDRX ON duration). In some aspects, the one or more CDRX parameters include a CDRX periodicity. In some aspects, the one or more CDRX parameters include a PDCCH skipping length (e.g., a length of time during which the UE 120 is skip PDCCH monitoring during a given CDRX ON duration). Notably, these CDRX parameters are provided as examples, and the one or more CDRX parameters may in some aspects include one or more other parameters associated with CDRX operation.

In some aspects, the one or more CDRX parameters are to be applied to a single CDRX cycle. That is, in some aspects, the UE 120 may be signaled or configured to apply the one or more CDRX parameters indicated by the base station 110 to a single CDRX cycle, such as a next CDRX cycle (e.g., a CDRX cycle immediately following the communication of the one or more CDRX parameters). Alternatively, in some aspects, the one or more CDRX parameters are to be applied to a plurality of CDRX cycles. That is, in some aspects, the UE 120 may be signaled or configured to apply the one or more CDRX cycles indicated by the base station 110 to multiple CDRX cycles, such as a next three CDRX cycles or an unspecified quantity of CDRX cycles (in which case the UE 120 may apply the one or more CDRX parameters until additional or different CDRX parameters are indicated by the base station 110). In some aspects, the quantity of CDRX cycles to which the one or more CDRX parameters are to be applied may be signaled by the base station 110 or configured on the UE 120.

In some aspects, the base station 110 may determine the one or more CDRX parameters based at least in part on one or more characteristics associated with traffic communicated between the base station 110 and the UE 120. Further details and examples of determination of the one or more CDRX parameters by the base station 110 are provided below.

As shown by reference 410, the base station 110 may transmit, and the UE 120 may receive, a wake-up signal including the one or more CDRX parameters. In some aspects, the wake-up signal is a signal that can be received by the UE 120 prior to waking up for a CDRX ON duration in a given CDRX cycle. Generally, a wake-up signal is used to inform the UE 120 whether there is downlink traffic for the UE 120 on an upcoming PDSCH. When the wake-up signal indicates that there is no traffic for the UE 120, the UE 120 can remain in the inactive state through the next CDRX ON duration, thereby conserving battery power. Conversely, when the wake-up signal indicates that there is traffic for the UE 120, the UE 120 can wake for the next CDRX ON duration. In some aspects, the wake-up signal may utilize a particular downlink control information (DCI) format, such as a DCI format 2_6 or DCI format 1_1. In some aspects, the one or more CDRX parameters may be included in the wake-up signal.

In some aspects, the wake-up signal is a first wake-up signal, and the one or more CDRX parameters include a parameter associated with a second wake-up signal to be received by the UE. For example, if the base station 110 has not received any packet from a burst anticipated by the base station 110 by a time of an occasion associated with transmitting the wake-up signal, then the base station 110 may use the first wake-up signal to notify the UE 120 of a second wake-up signal (e.g., an indication of an occasion for another wake-up signal), with the expectation that at least one packet in the burst will be received at the base station 110 by a time at which the second wake-up signal is to be transmitted. Continuing with this example, if the base station 110 has not received any packet by the second wake-up signal occasion, then the base station 110 can, for example, indicate a default CDRX parameter (e.g., a default wake-up signal offset) or indicate a third wake-up signal occasion to the UE 120.

In some aspects, the base station 110 may transmit the wake-up signal including the one or more CDRX parameters based at least in part on a request from the UE 120. For example, the UE 120 may transmit a request for CDRX parameters (e.g., a request for a particular subset of CDRX parameters, a request for updated CDRX parameters, or the like). Here, the base station 110 may receive the request and may transmit the one or more CDRX parameters in the wake-up signal in response to the request.

In some aspects, the base station 110 may transmit, and the UE 120 may receive, one or more other CDRX parameters in another type of downlink communication, such as a PDCCH communication, a PDSCH communication, or the like. For example, the base station 110 may transmit, and the UE 120 may receive, a PDCCH communication including one or more other CDRX parameters. In some aspects, the PDCCH communication is communicated during the CDRX cycle and after transmitting the wake-up signal (i.e., during the CDRX cycle to which the one or more CDRX parameters included in the wake-up signal are to be applied). As another example, the base station 110 may transmit, and the UE 120 may receive, a PDSCH communication including one or more other CDRX parameters. In some aspects, the PDSCH communication the PDSCH communication is communicated during the CDRX cycle and after transmitting the wake-up signal. In some aspects, the one or more other CDRX parameters may be transmitted in the downlink communication due to a resource limitation of the wake-up signal. As one particular example, in some aspects, a wake-up signal offset and a CDRX ON duration may be included in the wake-up signal, while an inactivity timer may be included in a PDCCH communication (e.g., a scheduling DCI or a non-scheduling DCI) during the CDRX ON duration that follows the wake-up signal.

As shown by reference 415, the UE 120 may perform an operation associated with a CDRX cycle based at least in part on the one or more CDRX parameters. For example, the UE 120 may be in a CDRX ON duration at a time indicated by a wake-up signal offset included in the wake-up signal. As another example, the UE 120 may remain in the active state for a period of time corresponding to a CDRX ON duration included in the wake-up signal. As another example, the UE 120 may utilize an inactivity timer for a period of time corresponding to an inactivity timer included in the wake-up signal. As another example, the UE 120 may monitor the PDCCH according to a PDCCH monitoring periodicity included in the wake-up signal. Notably, these operations are provided as examples, and the UE 120 may perform one or more other CDRX-related operations based at least in part on the one or more CDRX parameters included in the wake-up signal.

In some aspects, when performing the operation associated with a CDRX cycle, the UE 120 may apply at least one CDRX parameter, from the one or more CDRX parameters, to the CDRX cycle. For example, the UE 120 may receive a wake-up signal including a set of CDRX parameters and may apply a subset of the one or more CDRX parameters (e.g., based at least in part on a configuration of the UE 120). In such a scenario, in some aspects, the UE 120 may transmit, and the base station 110 may receive, an indication of the subset of CDRX parameters (e.g., to inform the base station 110 which of the one or more CDRX parameters the UE 120 applied).

As indicated above, in some aspects, the base station 110 may determine the one or more CDRX parameters based at least in part on a characteristic of traffic associated with the UE 120 and the base station 110.

For example, in some aspects, the base station 110 may determine the one or more CDRX parameters based at least in part on one or more packets, to be transmitted to the UE 120, being received prior to a time at which a wake-up signal is to be transmitted to the UE 120. FIG. 4B is a diagram associated with determination of a wake-up signal offset and CDRX ON duration in a scenario when one or more packets, to be transmitted to the UE 120, are received prior to a time at which a wake-up signal is to be transmitted to the UE 120. In FIG. 4B, a first packet in a second burst has arrived at the base station 110 (e.g., is ready for transmission to the UE 120) prior to a time of the second wake-up signal. In this example, the base station 110 determines an updated wake-up signal offset (e.g., a decreased wake-up signal offset) and transmits an indication of the updated wake-up signal offset in the second wake-up signal. As a result, as shown in FIG. 4B, the UE 120 begins the second CDRX ON duration at a time that is comparatively less offset from the second wake-up signal (e.g., as compared to a time at which the CDRX ON duration was started after the first wake-up signal).

Further, in some aspects, the base station 110 may store or have access to information (e.g., application awareness information) indicating a quantity of packets in the second burst, and information indicating an estimate of an inter-packet duration (e.g., an amount of time between packets) in the second burst. In such a case, the base station 110 may determine an updated CDRX ON duration (e.g., an increased CDRX ON duration) based at least in part on the quantity of packets and the estimated inter-packet duration. Here, the base station 110 may transmit an indication of the updated CDRX ON duration in the second wake-up signal. As a result, as shown in FIG. 4B, the second CDRX ON duration may be comparatively longer than the first CDRX ON duration (e.g., to enable the UE 120 to receive the packets in the second burst). Notably, one or more other CDRX parameters, such as an updated inactivity timer, an updated PDCCH monitoring periodicity, or the like, could also be transmitted to the UE 120 in the wake-up signal ahead of the CDRX ON duration.

As another example, in some aspects, the base station 110 may determine the one or more CDRX parameters based at least in part on an estimated jitter associated with a packet burst. For example, the base station 110 may store or have access to information (e.g., information indicating an encoding delay, information associated with a transmission route of the burst) based at least in part on which an amount of jitter associated with the packet burst may be estimated. The base station 110 may then determine one or more CDRX parameters, such as an updated wake-up offset, an updated inactivity time, or the like, based at least in part on the estimated jitter.

As another example, in some aspects, the base station 110 may determine the one or more CDRX parameters based at least in part on no packets of a packet burst that is to be transmitted to the UE 120 being received by a time at which the wake-up signal is to be transmitted. FIG. 4C is a diagram associated with determination of a wake-up signal parameter in a scenario when no packets of a packet burst that is to be transmitted to the UE 120 are received by a time at which the wake-up signal is to be transmitted. In FIG. 4C, a packet in a third burst has not arrived at the base station 110 by a time at which a third wake-up signal is to be transmitted. In this example, the base station 110 uses the third wake-up signal to inform the UE 120 of a fourth wake-up signal (with the expectation that the packet in the third burst would be received by the base station 110 at a time of the fourth wake-up signal). In this example, the packet in the third burst arrives at the base station 110 at a time prior to the fourth wake-up signal being transmitted, and the fourth wake-up signal includes an updated wake-up signal offset to be applied for initiating the third CDRX ON duration. As a result, as shown in FIG. 4C, the UE 120 begins the third CDRX ON duration at a time that is offset relative to the fourth wake-up signal (e.g., rather than a time that is offset relative to the third wake-up signal).

As another example, in some aspects, the base station 110 may determine the one or more CDRX parameters based at least in part on a period of a non-integer DRX cycle of traffic associated with the UE 120. For example, with reference to the middle diagram of FIG. 4D, a period of a DRX cycle associated with traffic (e.g., XR traffic) may be a non-integer value, whereas a period of a DRX cycle configured for the UE 120 may be an integer value, as indicated by the upper diagram in FIG. 4D. As a result of this difference, a drift may occur over time that causes the traffic and the CDRX ON durations to be increasingly misaligned. In some aspects, as illustrated in the lower diagram of FIG. 4D, the base station 110 may utilize one or more CDRX parameters, such as a wake-up signal offset, to adjust for the impact of the period of the non-integer DRX cycle of the traffic and reduce or eliminate the drift.

As indicated above, FIGS. 4A-4D are provided as examples. Other examples may differ from what is described with respect to FIGS. 4A-4D.

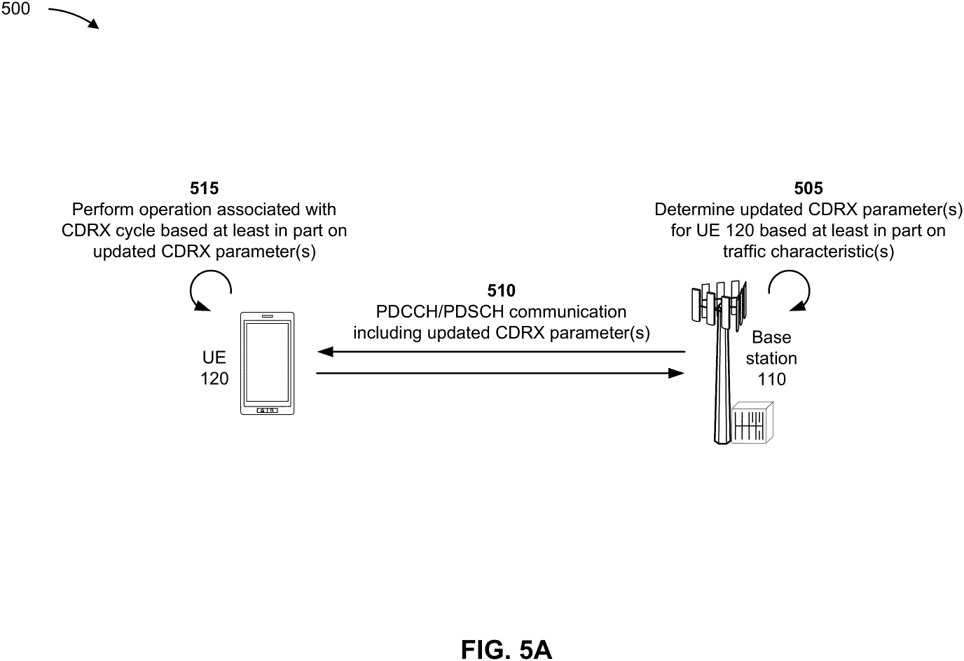

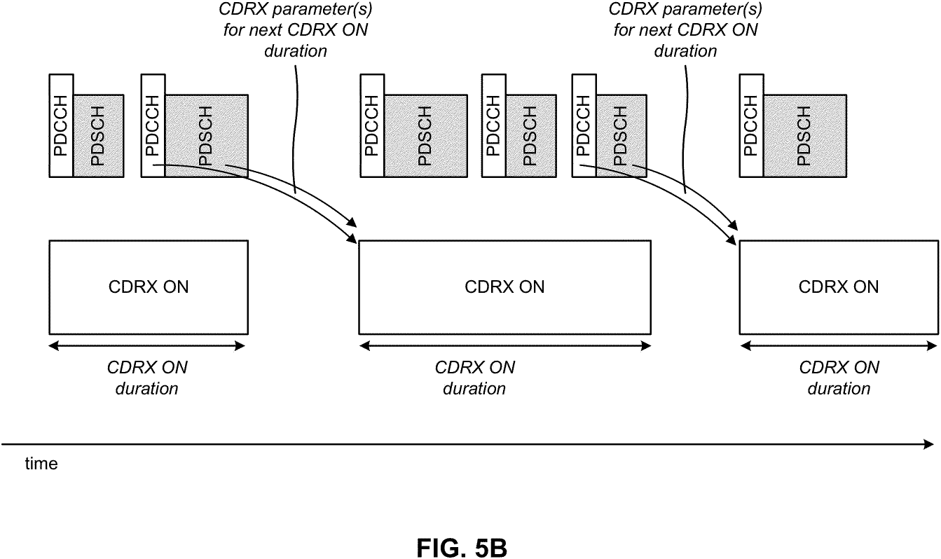

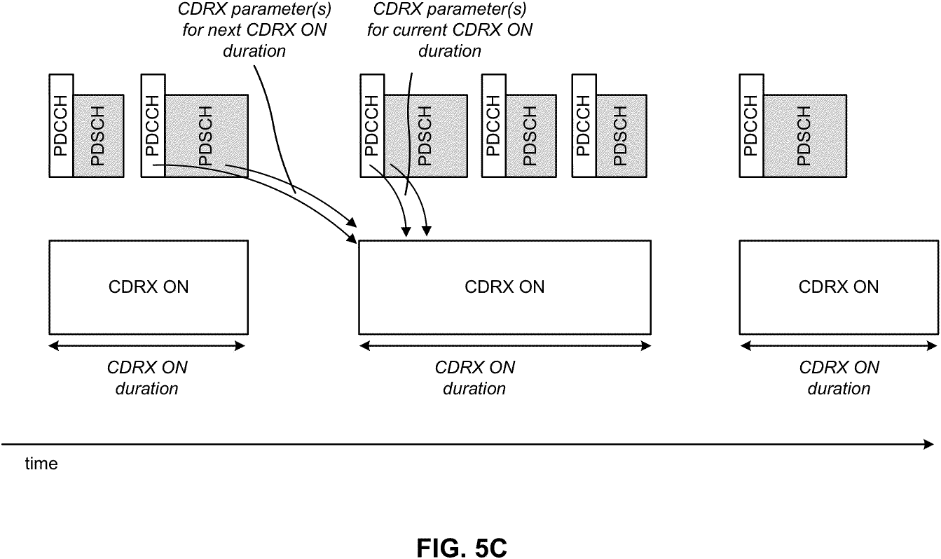

FIGS. 5A-5C are diagrams associated with an example 500 associated with adapting CDRX parameters based on traffic characteristics, in accordance with the present disclosure. As shown in FIG. 5A, example 500 includes communication between a base station 110 and a UE 120. In some aspects, the base station 110 and the UE 120 may be included in a wireless network, such as a wireless network 100. The base station 110 and the UE 120 may communicate via a wireless access link, which may include an uplink and a downlink.

As shown in FIG. 5A, by reference 505, the base station 110 may determine one or more CDRX parameters to be applied by the UE 120 to a CDRX cycle (e.g., an upcoming CDRX cycle). In some aspects, the one or more CDRX parameters may be updated CDRX parameters, as described above in association with FIGS. 4A-4D. In some aspects, the base station 110 may determine the one or more CDRX parameters in a manner described above with respect to FIGS. 4A-4D.

For example, in some aspects, the base station 110 may determine the one or more CDRX parameters based at least in part on one or more packets, to be transmitted to the UE 120, being received prior to a time of a wake-up associated with an upcoming CDRX ON duration. As another example, in some aspects, the base station 110 may determine the one or more CDRX parameters based at least in part on information indicating a quantity of packets included in a packet burst that is to be transmitted to the UE 120. As another example, in some aspects, the base station 110 may determine the one or more CDRX parameters based at least in part on an estimated inter-packet duration associated with a packet burst that is to be transmitted to the UE 120. As another example, in some aspects, the base station 110 may determine the one or more CDRX parameters based at least in part on an estimated jitter associated with a packet burst that is to be transmitted to the UE 120. As another example, in some aspects, the base station 110 may determine the one or more CDRX parameters based at least in part on no packets of a packet burst that is to be transmitted to the UE 120 being received by a time of a wake-up associated with an upcoming CDRX ON duration. As another example, in some aspects, the base station 110 may determine the one or more CDRX parameters based at least in part on a period of a non-integer DRX cycle of traffic associated with the UE 120.

As shown by reference 510, the base station 110 may transmit, and the UE 120 may receive, one or more downlink communications including the one or more CDRX parameters. In some aspects, the one or more downlink communications may include a PDCCH communication or a PDSCH communication.

In some aspects, the CDRX cycle is a second CDRX cycle, and at least one downlink communication of the one or more downlink communications is received during a CDRX ON duration of a first CDRX cycle that is prior to an ON duration of the second CDRX cycle. That is, in some aspects, at least one of the one or more downlink communications may be received during a CDRX ON duration prior to a CDRX ON duration for which the one or more CDRX parameters are to be applied. FIG. 5B is a diagram illustrating a PDCCH communication and a PDSCH communication in a first CDRX cycle being used to indicate one or more CDRX parameters associated with a second CDRX cycle.

In some aspects, at least one downlink communication of the one or more downlink communications is received during a CDRX ON duration of the CDRX cycle. That is, in some aspects, at least one of the one or more downlink communications may be received during the CDRX ON duration for which the one or more CDRX parameters are to be applied. FIG. 5C is a diagram illustrating a PDCCH communication and a PDSCH communication in a CDRX cycle being used to indicate one or more CDRX parameters associated with the CDRX cycle. Notably, as further illustrated in FIG. 5C, CDRX parameters associated with a given CDRX cycle may be indicated in downlink communications during different CDRX ON durations. For example, if resource limitations prevent all of the one or more CDRX parameters from being included in downlink communications during a first CDRX ON duration, some of the one or more CDRX parameters can be signaled in one or more downlink communications in a second (e.g., subsequent) CDRX ON duration. As one particular example, a starting time for the second CDRX ON duration and a length of the second CDRX ON duration may be transmitted in one or more downlink communications in the first CDRX ON duration, while one or more other CDRX parameters, such as a PDCCH monitoring periodicity and inactivity timer, may be transmitted in one or more downlink communications in the second CDRX ON duration (e.g., in a first PDCCH/PDSCH during the second CDRX ON duration).

In some aspects, the one or more downlink communications may include a PDCCH communication carrying DCI that schedules a PDSCH communication for the UE 120. Additionally, or alternatively, the one or more downlink communications may include a PDCCH communication carrying DCI that does not schedule a PDSCH communication for the UE 120. In some aspects, the one or more downlink communications include a PDCCH communication carrying DCI that utilizes DCI format 2_6 or DCI format 1_1.

In some aspects, the one or more downlink communications include a PDCCH communication only. In some aspects, the one or more downlink communications include a PDSCH communication only. In some aspects, the one or more downlink communications include both a PDCCH communication and a PDSCH communication.

In some aspects, the base station 110 transmits, and the UE 120 receives, the one or more CDRX parameters in a medium access control (MAC) control element. In some aspects, the base station 110 transmits, and the UE 120 receives, the one or more one or more CDRX parameters in a MAC header.

In some aspects, when the one or more downlink communications include a PDSCH communication, at least one CDRX parameter of the one or more CDRX parameters is transmitted by the base station 110, and received by the UE 120, in a CDRX payload that is appended to a data payload of the PDSCH communication.

In some aspects, when the one or more downlink communications include a PDSCH communication, at least one CDRX parameter of the one or more CDRX parameters is transmitted by the base station 110, and received by the UE 120, in a CDRX payload that is multiplexed with a data payload of the PDSCH communication.

As shown by reference 515, in FIG. 5A, the UE 120 may perform an operation associated with a CDRX cycle based at least in part on the one or more CDRX parameters. In some aspects, the UE 120 may perform the operation associated with the CDRX cycle in a manner similar to that described above in association with FIGS. 4A-4D.

As indicated above, FIGS. 5A-5C are provided as examples. Other examples may differ from what is described with respect to FIGS. 5A-5C.

FIG. 6 is a diagram illustrating an example process 600 performed, for example, by a UE, in accordance with the present disclosure. Example process 600 is an example where the UE (e.g., UE 120) performs operations associated with adapting CDRX parameters based on traffic characteristics.

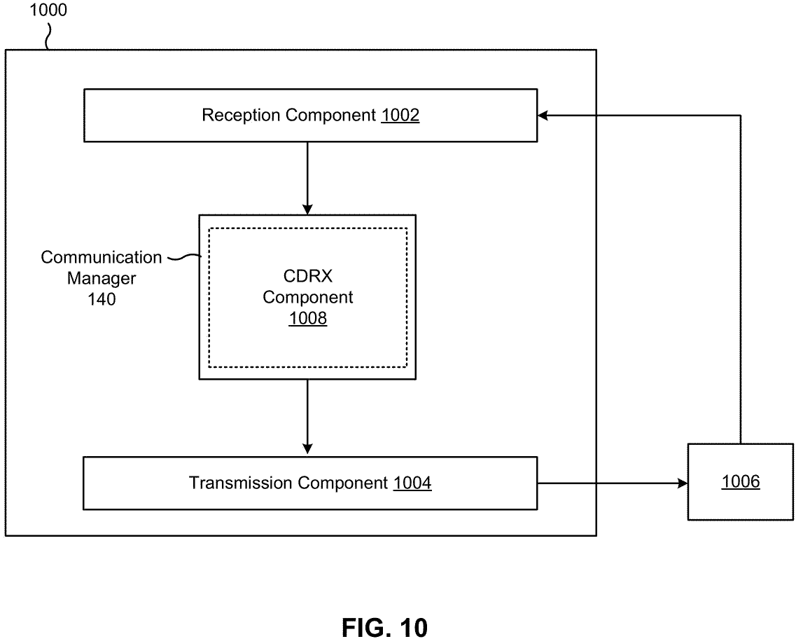

As shown in FIG. 6, in some aspects, process 600 may include receiving a wake-up signal including one or more connected mode discontinuous reception (CDRX) parameters (block 610). For example, the UE (e.g., using communication manager 140 and/or reception component 1002, depicted in FIG. 10) may receive a wake-up signal including one or more CDRX parameters, as described above.

As further shown in FIG. 6, in some aspects, process 600 may include performing an operation associated with a CDRX cycle based at least in part on the one or more CDRX parameters (block 620). For example, the UE (e.g., using communication manager 140 and/or CDRX component 1008, depicted in FIG. 10) may perform an operation associated with a CDRX cycle based at least in part on the one or more CDRX parameters, as described above.

Process 600 may include additional aspects, such as any single aspect or any combination of aspects described below and/or in connection with one or more other processes described elsewhere herein.

In a first aspect, the one or more CDRX parameters include a wake-up signal offset.

In a second aspect, alone or in combination with the first aspect, the one or more CDRX parameters include a CDRX ON duration.

In a third aspect, alone or in combination with one or more of the first and second aspects, the one or more CDRX parameters include at least one of an inactivity timer, a PDCCH monitoring periodicity, a CDRX periodicity, or a PDCCH skipping length.

In a fourth aspect, alone or in combination with one or more of the first through third aspects, the wake-up signal is a first wake-up signal, and the one or more CDRX parameters include a parameter associated with a second wake-up signal to be received by the UE.

In a fifth aspect, alone or in combination with one or more of the first through fourth aspects, the one or more CDRX parameters are to be applied to a single CDRX cycle.

In a sixth aspect, alone or in combination with one or more of the first through fifth aspects, the one or more CDRX parameters are to be applied to a plurality of CDRX cycles that includes the CDRX cycle.

In a seventh aspect, alone or in combination with one or more of the first through sixth aspects, the wake-up signal utilizes DCI format 2_6 or DCI format 1_1.

In an eighth aspect, alone or in combination with one or more of the first through seventh aspects, process 600 includes transmitting a request for CDRX parameters, wherein the one or more CDRX parameters are included in the wake-up signal in response to the request.

In a ninth aspect, alone or in combination with one or more of the first through eighth aspects, process 600 includes receiving a PDCCH communication including one or more other CDRX parameters.

In a tenth aspect, alone or in combination with one or more of the first through ninth aspects, the PDCCH communication is received during the CDRX cycle and after receiving the wake-up signal.

In an eleventh aspect, alone or in combination with one or more of the first through tenth aspects, process 600 includes receiving a PDSCH communication including one or more other CDRX parameters.

In a twelfth aspect, alone or in combination with one or more of the first through eleventh aspects, the PDSCH communication is received during the CDRX cycle and after receiving the wake-up signal.

In a thirteenth aspect, alone or in combination with one or more of the first through twelfth aspects, performing the operation associated with a CDRX cycle comprises applying at least one CDRX parameter, from the one or more CDRX parameters, to the CDRX cycle, and process 600 includes transmitting an indication of the at least one CDRX parameter.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a base station, in accordance with the present disclosure. Example process 700 is an example where the base station (e.g., base station 110) performs operations associated with adapting connected mode discontinuous reception parameters based on traffic characteristics.

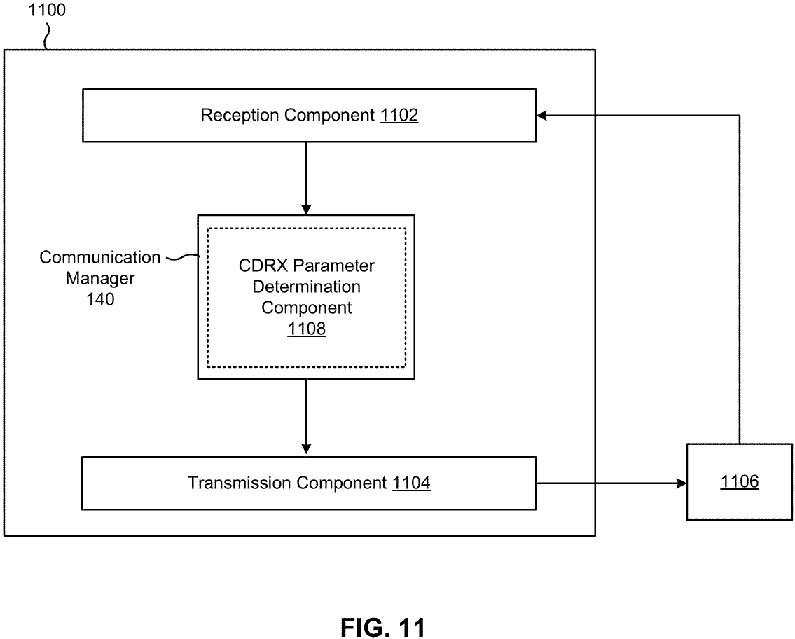

As shown in FIG. 7, in some aspects, process 700 may include determining one or more CDRX parameters to be applied by a UE to a CDRX cycle (block 710). For example, the base station (e.g., using communication manager 150 and/or CDRX parameter determination component 1108, depicted in FIG. 11) may determine one or more CDRX parameters to be applied by a UE to a CDRX cycle, as described above.

As further shown in FIG. 7, in some aspects, process 700 may include transmitting a wake-up signal including the one or more CDRX parameters (block 720). For example, the base station (e.g., using communication manager 150 and/or transmission component 1104, depicted in FIG. 11) may transmit a wake-up signal including the one or more CDRX parameters, as described above.

Process 700 may include additional aspects, such as any single aspect or any combination of aspects described below and/or in connection with one or more other processes described elsewhere herein.

In a first aspect, the one or more CDRX parameters include a wake-up signal offset.

In a second aspect, alone or in combination with the first aspect, the one or more CDRX parameters include a CDRX ON duration.

In a third aspect, alone or in combination with one or more of the first and second aspects, the one or more CDRX parameters include at least one of an inactivity timer, a PDCCH monitoring periodicity, a CDRX periodicity, or a PDCCH skipping length.

In a fourth aspect, alone or in combination with one or more of the first through third aspects, the wake-up signal is a first wake-up signal, and the one or more CDRX parameters include a parameter associated with a second wake-up signal to be transmitted to the UE.

In a fifth aspect, alone or in combination with one or more of the first through fourth aspects, the one or more CDRX parameters are to be applied by the UE to a single CDRX cycle.

In a sixth aspect, alone or in combination with one or more of the first through fifth aspects, the one or more CDRX parameters are to be applied by the UE to a plurality of CDRX cycles that includes the CDRX cycle.

In a seventh aspect, alone or in combination with one or more of the first through sixth aspects, the wake-up signal utilizes DCI format 2_6 or DCI format 1_1.

In an eighth aspect, alone or in combination with one or more of the first through seventh aspects, process 700 includes receiving a request for CDRX parameters from the UE, wherein the one or more CDRX parameters are transmitted in the wake-up signal in response to the request.

In a ninth aspect, alone or in combination with one or more of the first through eighth aspects, process 700 includes transmitting a PDCCH communication including one or more other CDRX parameters.

In a tenth aspect, alone or in combination with one or more of the first through ninth aspects, the PDCCH communication is transmitted during the CDRX cycle and after transmitting the wake-up signal.

In an eleventh aspect, alone or in combination with one or more of the first through tenth aspects, process 700 includes transmitting a PDSCH communication including one or more other CDRX parameters.

In a twelfth aspect, alone or in combination with one or more of the first through eleventh aspects, the PDSCH communication is transmitted during the CDRX cycle and after transmitting the wake-up signal.

In a thirteenth aspect, alone or in combination with one or more of the first through twelfth aspects, the one or more CDRX parameters are determined based at least in part on one or more packets, to be transmitted to the UE, being received prior to a time at which the wake-up signal is to be transmitted.

In a fourteenth aspect, alone or in combination with one or more of the first through thirteenth aspects, the one or more CDRX parameters are determined based at least in part on information indicating a quantity of packets included in a packet burst that is to be transmitted to or received from the UE.

In a fifteenth aspect, alone or in combination with one or more of the first through fourteenth aspects, the one or more CDRX parameters are determined based at least in part on an estimated inter-packet duration associated with a packet burst that is to be transmitted to or received from the UE.

In a sixteenth aspect, alone or in combination with one or more of the first through fifteenth aspects, the one or more CDRX parameters are determined based at least in part on an estimated jitter associated with a packet burst that is to be transmitted to or received from the UE.

In a seventeenth aspect, alone or in combination with one or more of the first through sixteenth aspects, the one or more CDRX parameters are determined based at least in part on no packets of a packet burst that is to be transmitted to the UE being received by a time at which the wake-up signal is to be transmitted.

In an eighteenth aspect, alone or in combination with one or more of the first through seventeenth aspects, the one or more CDRX parameters are determined based at least in part on a period of a non-integer discontinuous reception (DRX) cycle of traffic associated with the UE.

In a nineteenth aspect, alone or in combination with one or more of the first through eighteenth aspects, process 700 includes receiving an indication of at least one CDRX parameter, from the one or more CDRX parameters, applied by the UE to the CDRX cycle.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a UE, in accordance with the present disclosure. Example process 800 is an example where the UE (e.g., UE 120) performs operations associated with adapting connected mode discontinuous reception parameters based on traffic characteristics.

As shown in FIG. 8, in some aspects, process 800 may include receiving one or more downlink communications including one or more CDRX parameters, wherein the one or more downlink communications include at least one of a PDCCH communication or a PDSCH communication (block 810). For example, the UE (e.g., using communication manager 140 and/or reception component 1002, depicted in FIG. 10) may receive one or more downlink communications including one or more CDRX parameters, wherein the one or more downlink communications include at least one of a PDCCH communication or a PDSCH communication, as described above.

As further shown in FIG. 8, in some aspects, process 800 may include performing an operation associated with a CDRX cycle based at least in part on the one or more CDRX parameters (block 820). For example, the UE (e.g., using communication manager 140 and/or CDRX component 1008, depicted in FIG. 10) may perform an operation associated with a CDRX cycle based at least in part on the one or more CDRX parameters, as described above.

Process 800 may include additional aspects, such as any single aspect or any combination of aspects described below and/or in connection with one or more other processes described elsewhere herein.

In a first aspect, the one or more CDRX parameters include timing information for a wake-up associated with an upcoming CDRX ON duration.

In a second aspect, alone or in combination with the first aspect, the one or more CDRX parameters include a CDRX ON duration.

In a third aspect, alone or in combination with one or more of the first and second aspects, the one or more CDRX parameters include at least one of an inactivity timer, a PDCCH monitoring periodicity, a CDRX periodicity, or a PDCCH skipping length.

In a fourth aspect, alone or in combination with one or more of the first through third aspects, the CDRX cycle is a second CDRX cycle, and at least one downlink communication of the one or more downlink communications is received during a CDRX ON duration of a first CDRX cycle that is prior to an ON duration of the second CDRX cycle.

In a fifth aspect, alone or in combination with one or more of the first through fourth aspects, at least one downlink communication of the one or more downlink communications is received during a CDRX ON duration of the CDRX cycle.

In a sixth aspect, alone or in combination with one or more of the first through fifth aspects, the one or more downlink communications include a PDCCH communication carrying DCI that schedules a PDSCH communication for the UE.

In a seventh aspect, alone or in combination with one or more of the first through sixth aspects, the one or more downlink communications include a PDCCH communication carrying DCI that does not schedule a PDSCH communication for the UE.

In an eighth aspect, alone or in combination with one or more of the first through seventh aspects, the one or more downlink communications include a PDCCH communication carrying DCI that utilizes DCI format 2_6 or DCI format 1_1.

In a ninth aspect, alone or in combination with one or more of the first through eighth aspects, the one or more downlink communications include a PDCCH communication and a PDSCH communication.

In a tenth aspect, alone or in combination with one or more of the first through ninth aspects, the one or more CDRX parameters are received in a MAC control element.

In an eleventh aspect, alone or in combination with one or more of the first through tenth aspects, the one or more CDRX parameters are received in a MAC header.

In a twelfth aspect, alone or in combination with one or more of the first through eleventh aspects, the one or more downlink communications include a PDSCH communication, and at least one CDRX parameter of the one or more CDRX parameters is received in a CDRX payload that is appended to a data payload of the PDSCH communication.

In a thirteenth aspect, alone or in combination with one or more of the first through twelfth aspects, the one or more downlink communications include a PDSCH communication, and at least one CDRX parameter of the one or more CDRX parameters is received in a CDRX payload that is multiplexed with a data payload of the PDSCH communication.

In a fourteenth aspect, alone or in combination with one or more of the first through thirteenth aspects, performing the operation associated with a CDRX cycle comprises applying at least one CDRX parameter, from the one or more CDRX parameters, to the CDRX cycle, and process 800 includes transmitting an indication of the at least one CDRX parameter.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a base station, in accordance with the present disclosure. Example process 900 is an example where the base station (e.g., base station 110) performs operations associated with adapting connected mode discontinuous reception parameters based on traffic characteristics.

As shown in FIG. 9, in some aspects, process 900 may include determining one or more CDRX parameters to be applied by a UE to a CDRX cycle (block 910). For example, the base station (e.g., using communication manager 150 and/or CDRX parameter determination component 1108, depicted in FIG. 11) may determine one or more CDRX parameters to be applied by a UE to a CDRX cycle, as described above.

As further shown in FIG. 9, in some aspects, process 900 may include transmitting one or more downlink communications including the one or more CDRX parameters, wherein the one or more downlink communications include at least one of a PDCCH communication or a PDSCH communication (block 920). For example, the base station (e.g., using communication manager 150 and/or transmission component 1104, depicted in FIG. 11) may transmit one or more downlink communications including the one or more CDRX parameters, wherein the one or more downlink communications include at least one of a PDCCH communication or a PDSCH communication, as described above.

Process 900 may include additional aspects, such as any single aspect or any combination of aspects described below and/or in connection with one or more other processes described elsewhere herein.

In a first aspect, the one or more CDRX parameters include timing information for a wake-up associated with an upcoming CDRX ON duration.

In a second aspect, alone or in combination with the first aspect, the one or more CDRX parameters include a CDRX ON duration.

In a third aspect, alone or in combination with one or more of the first and second aspects, the one or more CDRX parameters include at least one of an inactivity timer, a PDCCH monitoring periodicity, a CDRX periodicity, or a PDCCH skipping length.

In a fourth aspect, alone or in combination with one or more of the first through third aspects, the CDRX cycle is a second CDRX cycle, and at least one downlink communication of the one or more downlink communications is received during a CDRX ON duration of a first CDRX cycle that is prior to an ON duration of the second CDRX cycle.

In a fifth aspect, alone or in combination with one or more of the first through fourth aspects, at least one downlink communication of the one or more downlink communications is transmitted during a CDRX ON duration of the CDRX cycle.

In a sixth aspect, alone or in combination with one or more of the first through fifth aspects, the one or more downlink communications include a PDCCH communication carrying DCI that schedules a PDSCH communication for the UE.

In a seventh aspect, alone or in combination with one or more of the first through sixth aspects, the one or more downlink communications include a PDCCH communication carrying DCI that does not schedule a PDSCH communication for the UE.

In an eighth aspect, alone or in combination with one or more of the first through seventh aspects, the one or more downlink communications include a PDCCH communication carrying DCI that utilizes DCI format 2_6 or DCI format 1_1.

In a ninth aspect, alone or in combination with one or more of the first through eighth aspects, the one or more downlink communications include a PDCCH communication and a PDSCH communication.

In a tenth aspect, alone or in combination with one or more of the first through ninth aspects, the one or more CDRX parameters are transmitted in a MAC control element.

In an eleventh aspect, alone or in combination with one or more of the first through tenth aspects, the one or more CDRX parameters are transmitted in a MAC header.

In a twelfth aspect, alone or in combination with one or more of the first through eleventh aspects, the one or more downlink communications include a PDSCH communication, and at least one CDRX parameter of the one or more CDRX parameters is transmitted in a CDRX payload that is appended to a data payload of the PDSCH communication.

In a thirteenth aspect, alone or in combination with one or more of the first through twelfth aspects, the one or more downlink communications include a PDSCH communication, and at least one CDRX parameter of the one or more CDRX parameters is transmitted in a CDRX payload that is multiplexed with a data payload of the PDSCH communication.

In a fourteenth aspect, alone or in combination with one or more of the first through thirteenth aspects, the one or more CDRX parameters are determined based at least in part on one or more packets, to be transmitted to the UE, being received prior to a time of a wake-up associated with an upcoming CDRX ON duration.

In a fifteenth aspect, alone or in combination with one or more of the first through fourteenth aspects, the one or more CDRX parameters are determined based at least in part on information indicating a quantity of packets included in a packet burst that is to be transmitted to or received from the UE.

In a sixteenth aspect, alone or in combination with one or more of the first through fifteenth aspects, the one or more CDRX parameters are determined based at least in part on an estimated inter-packet duration associated with a packet burst that is to be transmitted to or received from the UE.

In a seventeenth aspect, alone or in combination with one or more of the first through sixteenth aspects, the one or more CDRX parameters are determined based at least in part on an estimated jitter associated with a packet burst that is to be transmitted to or received from the UE.

In an eighteenth aspect, alone or in combination with one or more of the first through seventeenth aspects, the one or more CDRX parameters are determined based at least in part on no packets of a packet burst that is to be transmitted to the UE being received by a time of a wake-up associated with an upcoming CDRX ON duration.

In a nineteenth aspect, alone or in combination with one or more of the first through eighteenth aspects, the one or more CDRX parameters are determined based at least in part on a period of a non-integer DRX cycle of traffic associated with the UE.

In a twentieth aspect, alone or in combination with one or more of the first through nineteenth aspects, process 900 includes receiving an indication of at least one CDRX parameter, from the one or more CDRX parameters, applied by the UE to the CDRX cycle.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 140. The communication manager 140 may include a CDRX component 1008, among other examples.

In some aspects, the apparatus 1000 may be configured to perform one or more operations described herein in connection with FIGS. 4A-5C. Additionally, or alternatively, the apparatus 1000 may be configured to perform one or more processes described herein, such as process 600 of FIG. 6, process 800 of FIG. 8, or a combination thereof. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The reception component 1002 may receive a wake-up signal including one or more CDRX parameters. The CDRX component 1008 may perform an operation associated with a CDRX cycle based at least in part on the one or more CDRX parameters. The transmission component 1004 may transmit a request for CDRX parameters, wherein the one or more CDRX parameters are included in the wake-up signal in response to the request. The reception component 1002 may receive a PDCCH communication including one or more other CDRX parameters. The reception component 1002 may receive a PDSCH communication including one or more other CDRX parameters.

The reception component 1002 may receive one or more downlink communications including one or more CDRX parameters, wherein the one or more downlink communications include at least one of a PDCCH communication or a PDSCH communication. The CDRX component 1008 may perform an operation associated with a CDRX cycle based at least in part on the one or more CDRX parameters. The transmission component 1004 may transmit an indication of at least one CDRX parameter, from the one or more CDRX parameters, applied by the UE to the CDRX cycle.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication. The apparatus 1100 may be a base station, or a base station may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 150. The communication manager 150 may include a CDRX parameter determination component 1108, among other examples.

In some aspects, the apparatus 1100 may be configured to perform one or more operations described herein in connection with FIGS. 4A-5C. Additionally, or alternatively, the apparatus 1100 may be configured to perform one or more processes described herein, such as process 700 of FIG. 7, process 900 of FIG. 9, or a combination thereof. In some aspects, the apparatus 1100 and/or one or more components shown in FIG. 11 may include one or more components of the base station described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the base station described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the base station described in connection with FIG. 2. In some aspects, the transmission component 1104 may be co-located with the reception component 1102 in a transceiver.

The CDRX parameter determination component 1108 may determine one or more CDRX parameters to be applied by a UE to a CDRX cycle. The transmission component 1104 may transmit a wake-up signal including the one or more CDRX parameters. The reception component 1102 may receive a request for CDRX parameters from the UE, wherein the one or more CDRX parameters are transmitted in the wake-up signal in response to the request. The transmission component 1104 may transmit a PDCCH communication including one or more other CDRX parameters. The transmission component 1104 may transmit a PDSCH communication including one or more other CDRX parameters. The reception component 1102 may receive an indication of at least one CDRX parameter, from the one or more CDRX parameters, applied by the UE to the CDRX cycle.

The CDRX parameter determination component 1108 may determine one or more CDRX parameters to be applied by a UE to a CDRX cycle. The transmission component 1104 may transmit one or more downlink communications including the one or more CDRX parameters, wherein the one or more downlink communications include at least one of a PDCCH communication or a PDSCH communication. The reception component 1102 may receive an indication of at least one CDRX parameter, from the one or more CDRX parameters, applied by the UE to the CDRX cycle.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a UE, comprising: receiving a wake-up signal including one or more CDRX parameters; and performing an operation associated with a CDRX cycle based at least in part on the one or more CDRX parameters.

Aspect 2: The method of Aspect 1, wherein the one or more CDRX parameters include a wake-up signal offset.

Aspect 3: The method of any of Aspects 1-2, wherein the one or more CDRX parameters include a CDRX ON duration.

Aspect 4: The method of any of Aspects 1-3, wherein the one or more CDRX parameters include at least one of an inactivity timer, a PDCCH monitoring periodicity, a CDRX periodicity, or a PDCCH skipping length.

Aspect 5: The method of any of Aspects 1-4, wherein the wake-up signal is a first wake-up signal, and the one or more CDRX parameters include a parameter associated with a second wake-up signal to be received by the UE.

Aspect 6: The method of any of Aspects 1-5, wherein the one or more CDRX parameters are to be applied to a single CDRX cycle.

Aspect 7: The method of any of Aspects 1-5, wherein the one or more CDRX parameters are to be applied to a plurality of CDRX cycles that includes the CDRX cycle.

Aspect 8: The method of any of Aspects 1-7, wherein the wake-up signal utilizes DCI format 2_6 or DCI format 1_1.

Aspect 9: The method of any of Aspects 1-8, further comprising transmitting a request for CDRX parameters, wherein the one or more CDRX parameters are included in the wake-up signal in response to the request.

Aspect 10: The method of any of Aspects 1-9, further comprising receiving a PDCCH communication including one or more other CDRX parameters.

Aspect 11: The method of Aspect 10, wherein the PDCCH communication is received during the CDRX cycle and after receiving the wake-up signal.

Aspect 12: The method of any of Aspects 1-11, further comprising receiving a PDSCH communication including one or more other CDRX parameters.

Aspect 13: The method of Aspect 12, wherein the PDSCH communication is received during the CDRX cycle and after receiving the wake-up signal.

Aspect 14: The method of any of Aspects 1-13, wherein performing the operation associated with a CDRX cycle comprises applying at least one CDRX parameter, from the one or more CDRX parameters, to the CDRX cycle, and wherein the method further comprises transmitting an indication of the at least one CDRX parameter.

Aspect 15: A method of wireless communication performed by a base station, comprising: determining one or more CDRX parameters to be applied by a UE to a CDRX cycle; and transmitting a wake-up signal including the one or more CDRX parameters.

Aspect 16: The method of Aspect 15, wherein the one or more CDRX parameters include a wake-up signal offset.

Aspect 17: The method of any of Aspects 15-16, wherein the one or more CDRX parameters include a CDRX ON duration.

Aspect 18: The method of any of Aspects 15-17, wherein the one or more CDRX parameters include at least one of an inactivity timer, a PDCCH monitoring periodicity, a CDRX periodicity, or a PDCCH skipping length.

Aspect 19: The method of any of Aspects 15-18, wherein the wake-up signal is a first wake-up signal, and the one or more CDRX parameters include a parameter associated with a second wake-up signal to be transmitted to the UE.

Aspect 20: The method of any of Aspects 15-19, wherein the one or more CDRX parameters are to be applied by the UE to a single CDRX cycle.

Aspect 21: The method of any of Aspects 15-19, wherein the one or more CDRX parameters are to be applied by the UE to a plurality of CDRX cycles that includes the CDRX cycle.

Aspect 22: The method of any of Aspects 15-21, wherein the wake-up signal utilizes DCI format 2_6 or DCI format 1_1.

Aspect 23: The method of any of Aspects 15-22, further comprising receiving a request for CDRX parameters from the UE, wherein the one or more CDRX parameters are transmitted in the wake-up signal in response to the request.

Aspect 24: The method of Aspect 15, further comprising transmitting a PDCCH communication including one or more other CDRX parameters.

Aspect 25: The method of Aspect 24, wherein the PDCCH communication is transmitted during the CDRX cycle and after transmitting the wake-up signal.

Aspect 26: The method of any of Aspects 15-25, further comprising transmitting a PDSCH communication including one or more other CDRX parameters.

Aspect 27: The method of Aspect 26, wherein the PDSCH communication is transmitted during the CDRX cycle and after transmitting the wake-up signal.

Aspect 28: The method of any of Aspects 15-27, wherein the one or more CDRX parameters are determined based at least in part on one or more packets, to be transmitted to the UE, being received prior to a time at which the wake-up signal is to be transmitted.

Aspect 29: The method of any of Aspects 15-28, wherein the one or more CDRX parameters are determined based at least in part on information indicating a quantity of packets included in a packet burst that is to be transmitted to or received from the UE.

Aspect 30: The method of any of Aspects 15-29, wherein the one or more CDRX parameters are determined based at least in part on an estimated inter-packet duration associated with a packet burst that is to be transmitted to or received from the UE.

Aspect 31: The method of any of Aspects 15-30, wherein the one or more CDRX parameters are determined based at least in part on an estimated jitter associated with a packet burst that is to be transmitted to or received from the UE.

Aspect 32: The method of any of Aspects 15-31, wherein the one or more CDRX parameters are determined based at least in part on no packets of a packet burst that is to be transmitted to the UE being received by a time at which the wake-up signal is to be transmitted.

Aspect 33: The method of any of Aspects 15-32, wherein the one or more CDRX parameters are determined based at least in part on a period of a non-integer DRX cycle of traffic associated with the UE.

Aspect 34: The method of any of Aspects 15-33, further comprising receiving an indication of at least one CDRX parameter, from the one or more CDRX parameters, applied by the UE to the CDRX cycle.

Aspect 35: A method of wireless communication performed by a UE, comprising: receiving one or more downlink communications including one or more CDRX parameters, wherein the one or more downlink communications include at least one of a PDCCH communication or a PDSCH communication; and performing an operation associated with a CDRX cycle based at least in part on the one or more CDRX parameters.

Aspect 36: The method of Aspect 35, wherein the one or more CDRX parameters include timing information for a wake-up associated with an upcoming CDRX ON duration.

Aspect 37: The method of any of Aspects 35-36, wherein the one or more CDRX parameters include a CDRX ON duration.

Aspect 38: The method of any of Aspects 35-37, wherein the one or more CDRX parameters include at least one of an inactivity timer, a PDCCH monitoring periodicity, a CDRX periodicity, or a PDCCH skipping length.

Aspect 39: The method of any of Aspects 35-38, wherein the CDRX cycle is a second CDRX cycle, and at least one downlink communication of the one or more downlink communications is received during a CDRX ON duration of a first CDRX cycle that is prior to an on duration of the second CDRX cycle.

Aspect 40: The method of any of Aspects 35-39, wherein at least one downlink communication of the one or more downlink communications is received during a CDRX ON duration of the CDRX cycle.

Aspect 41: The method of any of Aspects 35-40, wherein the one or more downlink communications include a PDCCH communication carrying DCI that schedules a PDSCH communication for the UE.

Aspect 42: The method of any of Aspects 35-41, wherein the one or more downlink communications include a PDCCH communication carrying DCI that does not schedule a PDSCH communication for the UE.

Aspect 43: The method of any of Aspects 35-42, wherein the one or more downlink communications include a PDCCH communication carrying DCI that utilizes DCI format 2_6 or DCI format 1_1.

Aspect 44: The method of any of Aspects 35-43, wherein the one or more downlink communications include a PDCCH communication and a PDSCH communication.

Aspect 45: The method of any of Aspects 35-44, wherein the one or more CDRX parameters are received in a MAC control element.

Aspect 46: The method of any of Aspects 35-45, wherein the one or more CDRX parameters are received in a MAC header.

Aspect 47: The method of any of Aspects 35-46, wherein the one or more downlink communications include a PDSCH communication, and at least one CDRX parameter of the one or more CDRX parameters is received in a CDRX payload that is appended to a data payload of the PDSCH communication.

Aspect 48: The method of any of Aspects 35-47, wherein the one or more downlink communications include a PDSCH communication, and at least one CDRX parameter of the one or more CDRX parameters is received in a CDRX payload that is multiplexed with a data payload of the PDSCH communication.

Aspect 49: The method of any of Aspects 35-48, wherein performing the operation associated with a CDRX cycle comprises applying at least one CDRX parameter, from the one or more CDRX parameters, to the CDRX cycle, and wherein the method further comprises transmitting an indication of the at least one CDRX parameter.

Aspect 50: A method of wireless communication performed by a base station, comprising: determining one or more CDRX parameters to be applied by a UE to a CDRX cycle; and transmitting one or more downlink communications including the one or more CDRX parameters, wherein the one or more downlink communications include at least one of a PDCCH communication or a PDSCH communication.

Aspect 51: The method of Aspect 50, wherein the one or more CDRX parameters include timing information for a wake-up associated with an upcoming CDRX ON duration.

Aspect 52: The method of any of Aspects 50-51, wherein the one or more CDRX parameters include a CDRX ON duration.

Aspect 53: The method of any of Aspects 50-52, wherein the one or more CDRX parameters include at least one of an inactivity timer, a PDCCH monitoring periodicity, a CDRX periodicity, or a PDCCH skipping length.

Aspect 54: The method of any of Aspects 50-53, wherein the CDRX cycle is a second CDRX cycle, and at least one downlink communication of the one or more downlink communications is received during a CDRX ON duration of a first CDRX cycle that is prior to an on duration of the second CDRX cycle.

Aspect 55: The method of any of Aspects 50-54, wherein at least one downlink communication of the one or more downlink communications is transmitted during a CDRX ON duration of the CDRX cycle.

Aspect 56: The method of any of Aspects 50-55, wherein the one or more downlink communications include a PDCCH communication carrying DCI that schedules a PDSCH communication for the UE.

Aspect 57: The method of any of Aspects 50-56, wherein the one or more downlink communications include a PDCCH communication carrying DCI that does not schedule a PDSCH communication for the UE.

Aspect 58: The method of any of Aspects 50-57, wherein the one or more downlink communications include a PDCCH communication carrying DCI that utilizes DCI format 2_6 or DCI format 1_1.

Aspect 59: The method of any of Aspects 50-58, wherein the one or more downlink communications include a PDCCH communication and a PDSCH communication.

Aspect 60: The method of any of Aspects 50-59, wherein the one or more CDRX parameters are transmitted in a MAC control element.

Aspect 61: The method of any of Aspects 50-60, wherein the one or more CDRX parameters are transmitted in a MAC header.

Aspect 62: The method of any of Aspects 50-61, wherein the one or more downlink communications include a PDSCH communication, and at least one CDRX parameter of the one or more CDRX parameters is transmitted in a CDRX payload that is appended to a data payload of the PDSCH communication.

Aspect 63: The method of any of Aspects 50-62, wherein the one or more downlink communications include a PDSCH communication, and at least one CDRX parameter of the one or more CDRX parameters is transmitted in a CDRX payload that is multiplexed with a data payload of the PDSCH communication.

Aspect 64: The method of any of Aspects 50-63, wherein the one or more CDRX parameters are determined based at least in part on one or more packets, to be transmitted to the UE, being received prior to a time of a wake-up associated with an upcoming CDRX ON duration.

Aspect 65: The method of any of Aspects 50-64, wherein the one or more CDRX parameters are determined based at least in part on information indicating a quantity of packets included in a packet burst that is to be transmitted to or received from the UE.

Aspect 66: The method of any of Aspects 50-65, wherein the one or more CDRX parameters are determined based at least in part on an estimated inter-packet duration associated with a packet burst that is to be transmitted to or received from the UE.

Aspect 67: The method of any of Aspects 50-66, wherein the one or more CDRX parameters are determined based at least in part on an estimated jitter associated with a packet burst that is to be transmitted to or received from the UE.

Aspect 68: The method of any of Aspects 50-67, wherein the one or more CDRX parameters are determined based at least in part on no packets of a packet burst that is to be transmitted to the UE being received by a time of a wake-up associated with an upcoming CDRX ON duration.

Aspect 69: The method of any of Aspects 50-68, wherein the one or more CDRX parameters are determined based at least in part on a period of a non-integer DRX cycle of traffic associated with the UE.

Aspect 70: The method of any of Aspects 50-69, further comprising receiving an indication of at least one CDRX parameter, from the one or more CDRX parameters, applied by the UE to the CDRX cycle.

Aspect 71: An apparatus for wireless communication at a device, comprising a processor; memory coupled with the processor; and instructions stored in the memory and executable by the processor to cause the apparatus to perform the method of one or more of Aspects 1-14.

Aspect 72: A device for wireless communication, comprising a memory and one or more processors coupled to the memory, the one or more processors configured to perform the method of one or more of Aspects 1-14.

Aspect 73: An apparatus for wireless communication, comprising at least one means for performing the method of one or more of Aspects 1-14.

Aspect 74: A non-transitory computer-readable medium storing code for wireless communication, the code comprising instructions executable by a processor to perform the method of one or more of Aspects 1-14.

Aspect 75: A non-transitory computer-readable medium storing a set of instructions for wireless communication, the set of instructions comprising one or more instructions that, when executed by one or more processors of a device, cause the device to perform the method of one or more of Aspects 1-14.

Aspect 76: An apparatus for wireless communication at a device, comprising a processor; memory coupled with the processor; and instructions stored in the memory and executable by the processor to cause the apparatus to perform the method of one or more of Aspects 15-34.

Aspect 77: A device for wireless communication, comprising a memory and one or more processors coupled to the memory, the one or more processors configured to perform the method of one or more of Aspects 15-34.

Aspect 78: An apparatus for wireless communication, comprising at least one means for performing the method of one or more of Aspects 15-34.

Aspect 79: A non-transitory computer-readable medium storing code for wireless communication, the code comprising instructions executable by a processor to perform the method of one or more of Aspects 15-34.

Aspect 80: A non-transitory computer-readable medium storing a set of instructions for wireless communication, the set of instructions comprising one or more instructions that, when executed by one or more processors of a device, cause the device to perform the method of one or more of Aspects 15-34.

Aspect 81: An apparatus for wireless communication at a device, comprising a processor; memory coupled with the processor; and instructions stored in the memory and executable by the processor to cause the apparatus to perform the method of one or more of Aspects 35-49.

Aspect 82: A device for wireless communication, comprising a memory and one or more processors coupled to the memory, the one or more processors configured to perform the method of one or more of Aspects 35-49.

Aspect 83: An apparatus for wireless communication, comprising at least one means for performing the method of one or more of Aspects 35-49.

Aspect 84: A non-transitory computer-readable medium storing code for wireless communication, the code comprising instructions executable by a processor to perform the method of one or more of Aspects 35-49.

Aspect 85: A non-transitory computer-readable medium storing a set of instructions for wireless communication, the set of instructions comprising one or more instructions that, when executed by one or more processors of a device, cause the device to perform the method of one or more of Aspects 35-49.

Aspect 86: An apparatus for wireless communication at a device, comprising a processor; memory coupled with the processor; and instructions stored in the memory and executable by the processor to cause the apparatus to perform the method of one or more of Aspects 50-70.

Aspect 87: A device for wireless communication, comprising a memory and one or more processors coupled to the memory, the one or more processors configured to perform the method of one or more of Aspects 50-70.

Aspect 88: An apparatus for wireless communication, comprising at least one means for performing the method of one or more of Aspects 50-70.

Aspect 89: A non-transitory computer-readable medium storing code for wireless communication, the code comprising instructions executable by a processor to perform the method of one or more of Aspects 50-70.

Aspect 90: A non-transitory computer-readable medium storing a set of instructions for wireless communication, the set of instructions comprising one or more instructions that, when executed by one or more processors of a device, cause the device to perform the method of one or more of Aspects 50-70.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a + b, a + c, b + c, and a + b + c, as well as any combination with multiples of the same element (e.g., a + a, a + a + a, a + a + b, a + a + c, a + b + b, a + c + c, b + b, b + b + b, b + b + c, c + c, and c + c + c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication, comprising:
a memory; and
one or more processors, coupled to the memory, configured to:
receive one or more downlink communications including one or more connected mode discontinuous reception (CDRX) parameters,
wherein the one or more downlink communications include at least one of a physical downlink control channel (PDCCH) communication or a physical downlink shared channel (PDSCH) communication; and
perform an operation associated with a CDRX cycle based at least in part on the one or more CDRX parameters.

2. The apparatus of claim 1, wherein the one or more CDRX parameters include at least one of an inactivity timer, a PDCCH monitoring periodicity, a CDRX periodicity, a PDCCH skipping length, a CDRX ON duration, or timing information for a wake-up associated with an upcoming CDRX ON duration.

3. The apparatus of claim 1, wherein the CDRX cycle is a second CDRX cycle, and at least one downlink communication of the one or more downlink communications is received during a CDRX ON duration of a first CDRX cycle that is prior to an on duration of the second CDRX cycle.

4. The apparatus of claim 1, wherein at least one downlink communication of the one or more downlink communications is to be received during a CDRX ON duration of the CDRX cycle.

5. The apparatus of claim 1, wherein the one or more downlink communications include at least one of:
a PDCCH communication carrying downlink control information (DCI) that schedules a PDSCH communication for the apparatus,
a PDCCH communication carrying DCI that does not schedule a PDSCH communication for the apparatus,
a PDCCH communication carrying DCI that utilizes DCI format 2_6 or DCI format 1_1, or
a PDCCH communication and a PDSCH communication.

6. The apparatus of claim 1, wherein the one or more CDRX parameters are to be received in at least one of a medium access control (MAC) control element or a MAC header.

7. The apparatus of claim 1, wherein the one or more downlink communications include a PDSCH communication, and at least one CDRX parameter of the one or more CDRX parameters is to be received in a CDRX payload that is appended to a data payload of the PDSCH communication or that is multiplexed with the data payload of the PDSCH communication.

8. The apparatus of claim 1, wherein the one or more processors, to perform the operation associated with a CDRX cycle, are configured to apply at least one CDRX parameter, from the one or more CDRX parameters, to the CDRX cycle, and
wherein the one or more processors are further configured to transmit an indication of the at least one CDRX parameter.

9. A first apparatus for wireless communication, comprising:
a memory; and
one or more processors, coupled to the memory, configured to:
determine one or more connected mode discontinuous reception (CDRX) parameters to be applied by a second apparatus to a CDRX cycle; and
transmit one or more downlink communications including the one or more CDRX parameters,
wherein the one or more downlink communications include at least one of a physical downlink control channel (PDCCH) communication or a physical downlink shared channel (PDSCH) communication.

10. The first apparatus of claim 9, wherein the one or more CDRX parameters include at least one of an inactivity timer, a PDCCH monitoring periodicity, a CDRX periodicity, a PDCCH skipping length, a CDRX ON duration, or timing information for a wake-up associated with an upcoming CDRX ON duration.

11. The first apparatus of claim 9, wherein the CDRX cycle is a second CDRX cycle, and at least one downlink communication of the one or more downlink communications is received during a CDRX ON duration of a first CDRX cycle that is prior to an on duration of the second CDRX cycle.

12. The first apparatus of claim 9, wherein at least one downlink communication of the one or more downlink communications is to be transmitted during a CDRX ON duration of the CDRX cycle.

13. The first apparatus of claim 9, wherein the one or more downlink communications include at least one of:
a PDCCH communication carrying downlink control information (DCI) that schedules a PDSCH communication for the first apparatus,
a PDCCH communication carrying DCI that does not schedule a PDSCH communication for the first apparatus,
a PDCCH communication carrying DCI that utilizes DCI format 2_6 or DCI format 1_1, or
a PDCCH communication and a PDSCH communication.

14. The first apparatus of claim 9, wherein the one or more CDRX parameters are transmitted in at least one of a medium access control (MAC) control element or a MAC header.

15. The first apparatus of claim 9, wherein the one or more downlink communications include a PDSCH communication, and at least one CDRX parameter of the one or more CDRX parameters is transmitted in a CDRX payload that is appended to a data payload of the PDSCH communication or that is multiplexed with a data payload of the PDSCH communication.

16. The first apparatus of claim 9, wherein the one or more CDRX parameters are determined based at least in part on one or more packets, to be transmitted to the second apparatus, being received prior to a time of a wake-up associated with an upcoming CDRX ON duration.

17. The first apparatus of claim 9, wherein, to determine the one or more CDRX parameters, the one or more processors are configured to determine the one or more CDRX parameters based at least in part on at least one of:
information indicating a quantity of packets included in a packet burst that is to be transmitted to or received from the second apparatus,
an estimated inter-packet duration associated with a packet burst that is to be transmitted to or received from the second apparatus,
an estimated jitter associated with a packet burst that is to be transmitted to or received from the second apparatus,
no packets of a packet burst that is to be transmitted to the second apparatus being received by a time of a wake-up associated with an upcoming CDRX ON duration, or
a period of a non-integer discontinuous reception (DRX) cycle of traffic associated with the second apparatus.

18. The first apparatus of claim 9, wherein the one or more processors are further configured to receive an indication of at least one CDRX parameter, from the one or more CDRX parameters, applied by the second apparatus to the CDRX cycle.

19. An apparatus for wireless communication, comprising:
a memory; and
one or more processors, coupled to the memory, configured to:
receive a wake-up signal including one or more connected mode discontinuous reception (CDRX) parameters; and
perform an operation associated with a CDRX cycle based at least in part on the one or more CDRX parameters.

20. The apparatus of claim 19, wherein the one or more CDRX parameters include at least one of a wake-up signal offset, a CDRX ON duration, an inactivity timer, a physical downlink control channel (PDCCH) monitoring periodicity, a CDRX periodicity, or a PDCCH skipping length.

21. The apparatus of claim 19, wherein the wake-up signal is a first wake-up signal, and the one or more CDRX parameters include a parameter associated with a second wake-up signal to be received by the apparatus.

22. The apparatus of claim 19, wherein the one or more processors are further configured to transmit a request for CDRX parameters, wherein the one or more CDRX parameters are included in the wake-up signal in response to the request.

23. The apparatus of claim 19, wherein the one or more processors are further configured to receive a physical downlink control channel (PDCCH) communication including one or more other CDRX parameters.

24. The apparatus of claim 19, wherein the one or more processors are further configured to receive a physical downlink shared channel (PDSCH) communication including one or more other CDRX parameters.

25. The apparatus of claim 19, wherein the one or more processors, to perform the operation associated with a CDRX cycle, are configured to apply at least one CDRX parameter, from the one or more CDRX parameters, to the CDRX cycle, and
wherein the one or more processors are further configured to transmit an indication of the at least one CDRX parameter.

26. A first apparatus for wireless communication, comprising:
a memory; and
one or more processors, coupled to the memory, configured to:
determine one or more connected mode discontinuous reception (CDRX) parameters to be applied by a second apparatus to a CDRX cycle; and
transmit a wake-up signal including the one or more CDRX parameters.

27. The first apparatus of claim 26, wherein the one or more CDRX parameters include at least one of a wake-up signal offset, a CDRX ON duration, an inactivity timer, a physical downlink control channel (PDCCH) monitoring periodicity, a CDRX periodicity, or a PDCCH skipping length.

28. The first apparatus of claim 26, wherein the wake-up signal is a first wake-up signal, and the one or more CDRX parameters include a parameter associated with a second wake-up signal to be transmitted to the second apparatus.

29. The first apparatus of claim 26, wherein the one or more processors are further configured to receive a request for CDRX parameters from the second apparatus, wherein the one or more CDRX parameters are transmitted in the wake-up signal in response to the request.

30. The first apparatus of claim 26, wherein, to determine the one or more CDRX parameters, the one or more processors are configured to determine the one or more CDRX parameters based at least in part on at least one of:
one or more packets, to be transmitted to the second apparatus, being received prior to a time at which the wake-up signal is to be transmitted,
information indicating a quantity of packets included in a packet burst that is to be transmitted to or received from the second apparatus,
an estimated inter-packet duration associated with a packet burst that is to be transmitted to or received from the second apparatus,
an estimated jitter associated with a packet burst that is to be transmitted to or received from the second apparatus,
no packets of a packet burst that is to be transmitted to the second apparatus being received by a time at which the wake-up signal is to be transmitted, or
a period of a non-integer discontinuous reception (DRX) cycle of traffic associated with the second apparatus.
